(19) United States
(12) Patent Application Publication
(10) Pub. No.: US 2026/0095332 A1
(43) Pub. Date: Apr. 2, 2026

(54) DIGITAL SIGNATURE SYSTEM, AND METHOD

(71) Applicant: NEC Corporation, Tokyo (JP)

(72) Inventors: Saki OTSUKI, Tokyo (JP); Hiroto TAMIYA, Tokyo (JP); Toshiyuki ISSHIKI, Tokyo (JP)

(73) Assignee: NEC Corporation, Tokyo (JP)

(21) Appl. No.: 19/333,435

(22) Filed: Sep. 19, 2025

(30) Foreign Application Priority Data
Sep. 27, 2024 (JP) 2024-169066

(51) Int. Cl. H04L 9/32; H04L 9/00; H04L 9/08

(52) U.S. Cl. CPC H04L 9/3247; H04L 9/008; H04L 9/0861; H04L 9/3231

(57) ABSTRACT

A first apparatus generates a first sketch and first verification information for transmission to a third apparatus, a second apparatus generates a second sketch and second verification information for transmission to the third apparatus, which includes a storage part to store N set(s) of the first sketch and the first verification information, and upon reception of the second sketch and the second verification information, for the N set(s) of the first sketch and the first verification information, restore a difference key from the first sketch of kth (1≤k≤N) set and the second sketch to identify, as a user ID, an ID corresponding to the kth set of the first sketch and the first verification information, wherein a predetermined condition is satisfied for the first verification information of the kth set, the second verification information and the difference key.

### CROSS REFERENCE TO RELATED APPLICATIONS

This application is based upon and claims the benefit of the priority of Japanese patent application No. 2024-169066, filed on Sep. 27, 2024, the disclosure of which is incorporated herein in its entirety by reference thereto.

### FIELD

The present disclosure relates to a digital signature system, method and non-transitory medium.

### BACKGROUND

Digital signature is a technology which enables to verify a creator of an electronic document and check that the document has not been altered after creation thereof.

A digital signature algorithm typically includes a sequence of fundamental processes: key generation, signing, and verification.

Key generation: A set of a signing key (secret key) sk and a verification key (public key) vk are generated.

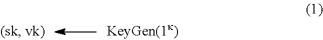

where κ is a security parameter.

Signing: A signature σ for a message (document) m to be signed is generated with the signing key sk. More specifically, the signature σ with the signing key (secret key) sk is generated for the message m or a hash value obtained by applying a hash function to the message m.

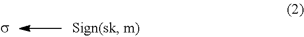

Verification: Correctness of the message (document) m and the signature σ is verified using the verification key vk.

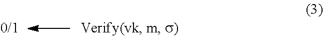

Verify ( ) is assumed to return 1 for acceptance and 0 for rejection.

A biometric-based signature scheme that uses biometric information as a key such as a signing key, would simplify management of a signing key (private keys) by a signer. As a signature scheme that uses biometric information as a signing key for a digital signature, a fuzzy signature scheme has been proposed which includes a sequence of the following processes (e.g., Reference Literature1).

Key generation: Using first biometric information (fuzzy data) w, a verification key is generated.

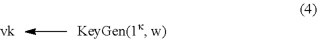

Signing: A signature σ is generated by inputting second biometric information (fuzzy data) w′ and a message to be signed to a signature algorithm Sign.

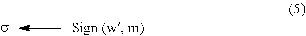

Verification: Correctness a set of the signature σ and the message m is verified by inputting the verification key, the signature σ and the message m to a verification algorithm Verify ( ).

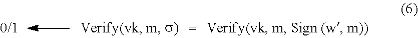

Verify ( ) is assumed to return 1 for acceptance and 0 for rejection.

NPL (Non-Patent Literature) 1 discloses a fuzzy signature system with a distributed signature scheme in which one of distributed keys is replaced with biometric information.
[NPL 1] Haruna Higo, Toshiyuki Isshiki, Saki Otsuki, Kenji Yasunaga, “Fuzzy Signature with Biometric-Independent Verification”, 2023 International Conference of the Biometrics Special Interest Group (BIOSIG), IEEE, 20-22 Sep. 2023

### SUMMARY

When a user is going to use a service such as electronic payment or point issuance provided by, for example, a business operator, simply by holding up his/her face or finger/palm at a terminal in a store or a facility, etc., with a fuzzy signature scheme (biometric-based signature scheme) or the like implemented therein, the user needs to be identified. This is because, if a verification key for verifying a signature is stored and managed for each user by a service provider, it is necessary to identify a user who has generated the signature and verify the signature with the verification key corresponding to the user identified.

It is desirable to provide a system that enables a reduction in a burden on each of a user side and an operator side and/or an improvement in security and efficiency.

In the present disclosure, there are disclosed a signature system, a method, and a non-transitory medium, each enabling the above issues to be solved.

In one of embodiments of the present disclosure, there is provided a signature system including at least a first apparatus, a second apparatus, and a third apparatus, each of which includes at least a processor, a memory storing a program executable by the processor, and a communication interface.

The processor included in the first apparatus is configured to:
generate a first sketch using user's first biometric information of a user and a first signing key;
generate first verification information based on the first signing key; and
transmit the first sketch and the first verification information to the third apparatus.

The processor includes in the second apparatus is configured to:
generate a second sketch using user's second biometric information and a second signing key;
generate second verification information based on the second signing key; and
transmit the second sketch and the second verification information to the third apparatus.

The third apparatus includes a storage part that stores N (where N is an integer not less than 1) set(s) of the first sketch and the first verification information transmitted from one or more instances of the first apparatus.

The third apparatus is configured to:
receive the second sketch and the second verification information transmitted from the second apparatus;
for the N set(s) of the first sketch and the first verification information stored in the storage part,
restore a difference key by using the first sketch of a kth set (where k is an integer not less than 1 and not more than N) and the second sketch; and
identify an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

In one of embodiments of the present disclosure, there is provided a signature method, comprising:
by a first apparatus:
generating a first sketch using user's first biometric information of a user and a first signing key;
generating first verification information based on the first signing key; and
transmitting the first sketch and the first verification information to the third apparatus, the method comprising:
by a second apparatus:
generating a second sketch using user's second biometric information and a second signing key;
generating second verification information based on the second signing key; and
transmitting the second sketch and the second verification information to the third apparatus, the method comprising:
by the third apparatus including a storage part that stores N (where N is an integer not less than 1) set(s) of the first sketch and the first verification information received from one or more instances of the first apparatus:
on reception of the second sketch and the second verification information transmitted from the second apparatus,
for the N set(s) of the first sketch and the first verification information stored in the storage part,
restoring a difference key by using the first sketch of a kth set (where k is an integer not less than 1 and not more than N) and the second sketch; and
identify an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

In one of embodiments of the present disclosure, there is provided a non-transitory medium storing a program causing a first processing apparatus to execute processing comprising:
generating a first sketch using user's first biometric information of a user and a first signing key;
generating first verification information based on the first signing key; and
transmitting the first sketch and the first verification information to the third apparatus, wherein the non-transitory medium stores a program causing a second processing apparatus to execute processing comprising:
generating a second sketch using user's second biometric information and a second signing key;
generating second verification information based on the second signing key; and
transmitting the second sketch and the second verification information to the third apparatus, and wherein the non-transitory medium stores a program causing the third processing apparatus to execute processing comprising:
storing in a storage part N (where Nis an integer not less than 1) set(s) of the first sketch and the first verification information received from one or more instances of the first processing apparatus;
on reception of the second sketch and the second verification information transmitted from the second apparatus,
for the N set(s) of the first sketch and the first verification information stored in the storage part,
restoring a difference key by using the first sketch of a kth set (where k is an integer not less than 1 and not more than N) and the second sketch; and
identifying an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

In one of embodiments of the present disclosure, there is provided a user ID identification apparatus including at least a processor, a memory storing a program executable by the processor, and a communication interface, the processor is configured to:
receive from one or more first apparatuses a first sketch generated using a first biometric information of a user and a first signing key, and first verification information generated based on the first signing key;
registers a set of the first sketch and the first verification information in a storage;
receives a second sketch generated using user's second biometric information a second signing key and second verification information generated based on the second signing key, and
for sets of the first sketch and the first verification information stored in the storage,
restore a difference key using the first sketch and the second sketch; and
identify an ID (identification information), as a user ID, the ID corresponding to a set of the first sketch and the first verification information for which a predetermined condition is satisfied for the first verification information, the second verification information, and the difference key.

In one of embodiments of the present disclosure, there is provided an authentication apparatus including at least a processor, a memory storing a program executable by the processor, and a communication interface, the processor is configured to:
receive, from each of one or more first apparatuses, a first sketch each generated using user's first biometric information and a first signing key, and first verification information generated based on the first signing key, and
register a set of the first sketch and the first verification information in a storage as enrollment information, and
receive a second sketch generated using second biometric information a user to be authenticated and a second signing key and the second verification information generated based on the second signing key, and
for sets of the first sketch and the first verification information stored in the storage,
restore a difference key using the first sketch and the second sketch, and
verifies whether a predetermined condition is satisfied for the first verification information, the second verification information, and the difference key, and
authenticate the user to be authenticated as the user of the first biometric information used to generate the first sketch, if the predetermined condition is satisfied.

According to the present disclosure, it is possible to reduce burden on a user side and burden on an operator side, and to improve safety and efficiency, in identification of a user when using a service with hands empty by means of signature based on biometric information (fuzzy data) or the like.

### BRIEF DESCRIPTION OF THE DRAWINGS

FIG. 1 is a diagram schematically illustrating an example of a signature system and processing of the present disclosure.

FIG. 2 is a diagram schematic illustrating an example of processing of the signature system of the present disclosure.

FIG. 3 is a diagram schematic illustrating an example of a configuration of a signature system of the present disclosure.

FIG. 4 is a diagram illustrating an example of the processing of the signature system of the present disclosure.

FIG. 5 is a diagram illustrating an example of the processing of the signature system of the present disclosure.

FIG. 6 is a diagram illustrating another example of the configuration of the signature system of the present disclosure.

FIG. 7 is a diagram illustrating another example of the processing of the signature system of the present disclosure.

FIG. 8 is a diagram illustrating an example of a use case of the wallet of the present disclosure.

FIG. 9 is a diagram illustrating an example of a use case of the wallet of the present disclosure.

FIG. 10A and FIG. 10B are diagrams each illustrating an implementation example of a computer system.

### EXAMPLE EMBODIMENTS

The following describes several embodiments and examples of the present disclosure.

In a case where a user uses a service provided by a business, such as electronic payment with hands empty by means of a biometric signature, at a terminal or the like in a store or facility, a method to identify the user includes, for example, the following.
When generating a biometric signature, a user enters a user ID (identification information).

In this case, a meritorious feature of the biometric signature scheme that the user does not need to memorize or possess a user ID may be lost. For example, if the number of users (N) registered on a business side becomes enormous, N users cannot be uniquely identified by just their names.
Biometric information is linked to a key ID and registered on a server side in advance, and biometric information is used for 1: N identity authentication (biometric authentication).

In this case, biometric information must be registered in advance on the server side (business side), which increases a burden on the business side and raises concerns about security, such as a risk of biometric information compromise or leakage. Biometric information is a part of a body, and once compromised, it cannot be changed or discarded. In order to avoid compromise of biometric information, encryption of data and construction of a robust system are required, which would increase a burden on the server side (provider side).
Search for enrollment information close to biometric information by performing biometric-based signature by brute force.

For example, a method in which biometric signatures are verified by brute force until signature verification succeeds and an ID (identification information) corresponding to a verification key with which the signature verification succeeds is adopted, but such a method is extremely inefficient. As a similar method, a system is known in which a verification node receiving a biometric digital signature generated from biometric information (biometric-based signature) compares it with a prior biometric digital signature for a user and determine that the biometric digital signature is the same as the prior biometric digital signature for the user, and when the biometric digital signature is determined to be the same as the prior biometric digital signature for the user, the user is verified (Reference 6). This method is similarly inefficient as a method for identifying users.

The above is a list of typical examples of possible user identification, and the above issues are only examples. The present disclosure discloses a system that can solve at least the above issues. That is, the present disclosure below discloses a signature system (method, etc.) that can reduce a burden on a user side, reduce a burden on an operator side that provides a service(s) at a store(s), facility (ies), etc., and enables to improve safety and efficiency.

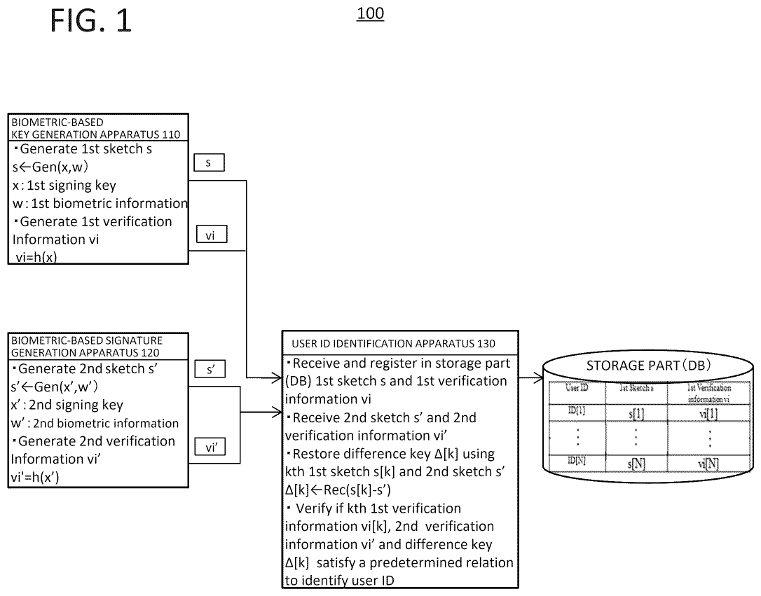

FIG. 1 illustrates an example of a system and processing of at least one embodiment of the present disclosure. Referring to FIG. 1, a biometric-based key generation apparatus 110 (first apparatus) may generate a first sketch s using a first biometric information w of a user and a first signing key x.

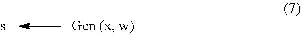

where Gen is a linear sketch generation algorithm (function).

The biometric-based key generation apparatus 110 (first apparatus) may generate first verification information vi based on the first signing key x.

$$vi = h ( x ) \qquad ( 8 )$$

where h is a homomorphic (additive-homomorphic) one-way function that generates the verification information vi from the signing key x, for example.

The biometric-based key generation apparatus 110 (first apparatus) may transmit the first sketch s and the first verification information vi to a user ID identification apparatus 130 (third apparatus).

The biometric-based signature generation apparatus 120 (second apparatus), may generate a second sketch s′ using the user's second biometric information w′ and a second signing key x′ during signature generation (signing phase).

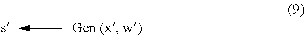

The biometric-based signature generation apparatus 120 (second apparatus) generates second verification information vi′ based on the second signing key x′.

$${vi}^{′} = h ( {x}^{′} ) \qquad ( 10 )$$

The biometric-based signature generation apparatus 120 (second apparatus) may transmit the second sketch s′ and the second verification information vi′ to the user ID identification apparatus 130 (third apparatus).

The user ID identification apparatus 130 (third apparatus) may include a storage part (database: DB) (not shown) that stores one or more sets (pairs) of the first sketch s′ and the first verification information vi′ transmitted from one or more biometric-based key generation apparatus 110 (first apparatus(es)).

When the user ID identification apparatus 130 (third apparatus) receives the second sketch s′ and the second verification information vi′ from the biometric-based signature generation apparatus 120 (second apparatus), the user ID identification apparatus 130 (third apparatus) may, for kth (1≤k≤N) set of the first sketch s[k] and the first verification information vi[k] out of N (Nis an integer not less than 1) set(s) of the first sketch s and the first verification information vi stored in the storage part (DB), restores (recovers) a difference key Δ[k] using a recovery function Rec( ) with the first sketch s[k] and the second sketch s′ as input arguments thereof.

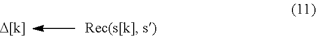

In the present disclosure, the kth (kth row) sets of the first sketch s and the first verification information vi out of N sets (N: positive integer) of the first sketch s and the first verification information vi stored in the storage part (DB) are respectively denoted as s[k] and vi[k]. The first signing key x and the first biometric information w used to generate the kth set of first sketches s[k] may be also denoted as x[k] and w[k].

When a predetermined condition is satisfied for the first verification information vi[k], the second verification information vi′, and the difference key Δ[k], the user ID identification apparatus 130 (the third apparatus) identifies as a user ID, an ID[k] corresponding to the kth set (first sketch s[k] and first verification information vi[k]) stored in the storage part (DB). The ID[k] ((ID[k] may be k) may be regarded to correspond to an ID (user ID) of the user of the second biometric information w′ used to generate the second sketch s′ which are used to restore the difference key Δ[k] along with the first sketch s[k].

The biometric-based key generation apparatus 110 (first apparatus) may apply a homomorphic one-way function h to the first signing key x to generate the first verification information vi. The biometric-based signature generation apparatus 120 (second apparatus) may generate the second verification information vi′ by applying the homomorphic one-way function h to the second signing key x′.

The user ID identification apparatus 130 (third apparatus) may check for the kth set of the first sketch and the first verification information vi, whether the predetermined condition holds by checking whether a result of the operation of a value h(Δ[k]) obtained by applying the homomorphic one-way function h to the difference key Δ[k] and the second verification information vi′(=h(x′)) obtained by applying the homomorphic one-way function h to the second signing key x′ is additive-homomorphic with the first verification information vi(=h(x)) obtained by applying the homomorphic one-way function h to the first signing key x.

$$h ( {x}^{′} ) * h ( Δ [ k ] ) = h ( x ) ( h ( {x}^{′} ) * h ( x - {x}^{′} ) = h ( x ) ) or \qquad ( 12 )$$

$$h ( {x}^{′} ) + h ( Δ [ k ] ) = h ( x ) ( h ( {x}^{′} ) + h ( x - {x}^{′} ) = h ( x ) )$$

The user ID identification apparatus 130 (third apparatus) may transmit the identified user ID to the biometric-based signature generation apparatus 120 (second apparatus), and the biometric-based signature generation apparatus 120 (second apparatus) may generate for the message m to be signed, the signature σ using the second biometric information w′ and/or the second signing key x′.

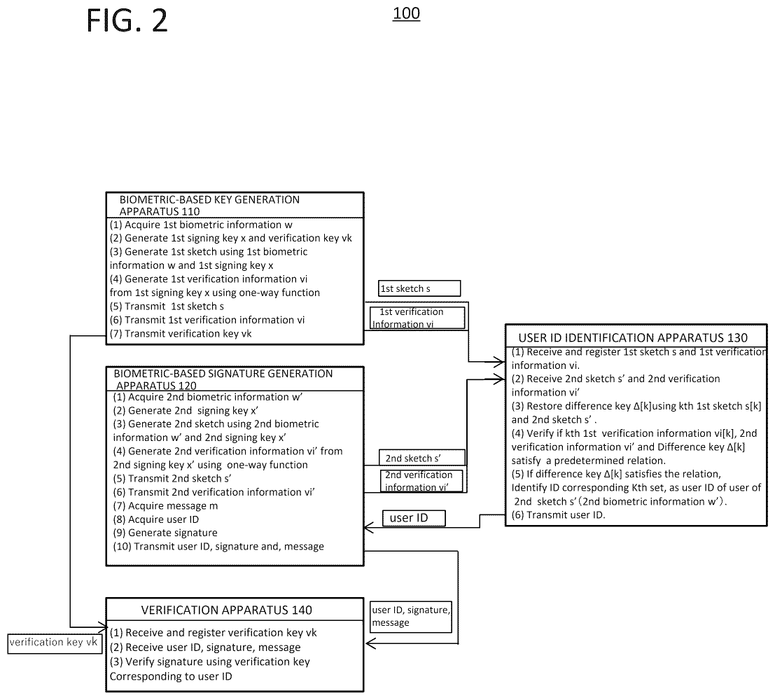

The biometric-based signature generation apparatus 120 (second apparatus) may transmit the user ID, signature σ and message m to a verification apparatus not shown (140 in FIG. 2, a fourth apparatus). The verification apparatus (140 in FIG. 2, the fourth apparatus) verifies the signature σ for the message m using the verification key vk corresponding to the user ID.

In signature generation (signing phase), the biometric-based signature generation apparatus 120 (second apparatus) may communicate with the user ID identification apparatus 130 (third apparatus) to generate first and second distributed signatures using the second signing key x′ and the difference key Δ[k](=Rec (s [k], s′)), respectively. The first and second distributed signatures may be combined to generate a signature. The signature generated by combining the first and second distributed signatures is equivalent to the signature generated for message m using the first signing key x[k], and can be verified using the verification key vk corresponding to the user ID.

Alternatively, as another method of signature generation, the biometric-based signature generation apparatus 120 (second apparatus) may generates a second signing key x′ and a second verification key vk′, generate a signature σ′ for the message m using the second signing key x′, and transmit the signature σ′, the second verification key vk′, and the second sketch s′ to the unshown to a verification apparatus not shown (the fourth apparatus). The biometric-based key generation apparatus 110 (first apparatus) may transmit the verification key vk and the first sketch s to the verification apparatus (fourth apparatus), which may verify the signature σ′ using the second verification key x′, restore a difference key Δ using the first sketch s and the second sketch s′, and verify whether the verification key vk, the second verification key vk′, and the difference key Δ corresponding to the user ID have a predetermined relationship (e.g., Reference Literature 5).

FIG. 2 illustrates an example of a signature system of an embodiment of the present disclosure. FIG. 2 illustrate a detailed example of the process of FIG. 1. Referring to FIG. 2, the signature system 100 includes a biometric-based key generation apparatus 110, a biometric-based signature generation apparatus 120, a user ID identification apparatus 130, and a verification apparatus 140. In FIG. 2, numbers in parentheses within each apparatus indicate processing step number in the apparatus. In FIG. 2, an arrow indicates transmission/reception of a signal(s) (information), but this does not mean unidirectional transmission. For example, an arrow may represent handshakes including:
transmission of an information acquisition request from a receiving apparatus to a transmitting apparatus;
transmission of information from the transmitting apparatus to the receiving apparatus; and
transmission of an acknowledgement from the receiving apparatus to the transmitting apparatus.

Alternatively, it may represent handshakes including:
transmission of a transmission request from the transmitting apparatus to the receiving apparatus;
transmission of an acknowledgement from the receiving apparatus to the transmitting apparatus;
transmission of information from the transmitting apparatus to the receiving apparatus; and
transmission of an acknowledgement from the receiving apparatus to the transmitting apparatus, etc. The same applies to the following drawings.

The biometric-based key generation apparatus 110 may include a processor and a communication interface (both not shown) and perform the following processes.
(Step 1) Acquire the first biometric information w of a user.
(Step 2) Generate the first signing key x and a verification key vk.
(Step 3) Generate the first sketch s using the first biometric information w and the first signing key x.
(Step 4) Generate the first verification information vi by applying a homomorphic one-way function to the first signing key x.
(Step 5) Transmit the first sketch s to the user ID identification apparatus 130.
(Step 6) Transmit the first verification information vi to the user ID identification apparatus 130.
(Step 7) Transmit the verification key vk to the verification apparatus 140.

The biometric-based key generation apparatus 110 may transmit the first sketch s and the first verification information vi simultaneously. The biometric-based key generation apparatus 110 may transmit the first sketch s and the first verification information vi together with a user ID. The biometric-based key generation apparatus 110 may transmit the verification key vk together with the user ID to the verification apparatus 140. When the biometric-based key generation apparatus 110 is a terminal of the user (e.g., mobile terminal), the user ID may be a terminal address or terminal ID. Steps 1 and 2 may be interchanged in order, steps 3 and 4 may also be interchanged in order, and steps 5, 6, and 7 may not necessarily be in this order.

The biometric-based signature generation apparatus 120 may include a processor and a communication interface (both not shown) and may perform the following processes.
(Step 1) Acquire the second biometric information w′.
(Step 2) Generate the second signing key x′.
(Step 3) Generate a second sketch s′ using the second biometric information w′ and the second signing key x′.
(Step 4) Generate the second verification information vi′ by applying a homomorphic one-way function to the second signing key x′.
(Step 5) Transmit the second sketch s′ to the user ID identification apparatus 130.
(Step 6) Transmit the second verification information vi′ to the user ID identification apparatus 130.
(Step 7) Acquire a message m to be signed.
(Step 8) Obtains a user ID from the user ID identification apparatus 130.
(Step 9) Generate a signature σ.
(Step 10) Transmit the user ID, signature σ, and message m to the verification apparatus 140.

It is noted that steps 1 and 2 may be interchanged in order, steps 3 and 4 may also be interchanged in order, steps 5 and 6 do not necessarily have to be in this order, and step 7 may be in any order as long as it is before step 9.

The user ID identification apparatus 130 may include a processor and a communication interface (both not shown) and may perform the following processes.

(Step 1) Receive the first sketch s and the first verification information vi and perform registration thereof in correspondence with the user ID in a storage part. The user ID identification apparatus 130 may automatically assign an ID to a set of the user's first sketch s and the first verification information vi that are to be registered in a storage part. For example, a row number of a record including the user's first sketch s and the first verification information vi in the storage part (database: DB) may be assigned s a user ID, though not limited thereto.

(Step 2) Receive the second sketch s′ and the second verification information vi′ transmitted from the biometric-based signature generation apparatus 120.

(Step 3) Obtain a difference key Δ[k] (=Rec(s [k], s′)) using the kth (1≤k≤N) first sketch s[k] and second sketch s′ registered in the storage part (DB).

(Step 4) Verify whether or not the kth (1≤k≤N) set of the first verification information vi[k] registered in the storage part (DB), the second verification information vi′ and the difference key Δ[k] satisfy a predetermined condition (relationship).

(Step 5) When a verification result of the difference key Δ[k] is successful (Okay), an ID corresponding to the kth set stored in the storage part is identified as a user ID of the user of the second biometric information w′ corresponding to the second sketch s′. That is, when it is confirmed that the kth first verification information vi[k] of the kth (1≤k≤N) set stored in the storage part and the second verification information vi′ and the difference key Δ[k] obtained in step 3 satisfy the predetermined condition (relationship) (the equality Δ[k]=x[k]−x′ holds), the second biometric information w′ corresponding to the second sketch s′ and the first biometric information w[k] corresponding to the first sketch s[k] of the kth (1≤k≤N) set are determined to be those of the same user because a difference (distance) between them is within an error correction range, and the ID[k] corresponding to the kth set is identified as a user ID of the second biometric information w. The ID[k] corresponding to the kth set may be a row number k (1≤k≤N). Alternatively, the ID[k] may be, for example, a value of ID[k] stored in a record along with the first sketch s[k] and the first verification information vi[k] as the kth set (user ID registered in advance) in the storage part).

(Step 6) The user ID identification apparatus 130 transmits the user ID to the biometric-based signature generation apparatus 120.

The verification apparatus 140 may include a processor apparatus and a communication interface (both not shown), and perform the following processes.

(Step 1) Receive the verification key vk and register it a storage part of the verification apparatus 140 in correspondence with the user ID. A plurality of verification keys are registered corresponding to a plurality of users. In the verification apparatus 140, the user ID may be stored as the kth set in the storage part of the verification apparatus 140, in correspondence with the first sketch s[k] and the first verification information vi[k] of the user, which are stored as the kth set in the storage part of the user ID identification apparatus 130. Alternatively, the verification key vk may be stored as the kth set in the storage part of the verification apparatus 140, in correspondence with the kth set of ID[k] (user ID) stored in the storage part of the user ID identification apparatus 130.

(Step 2) Receive the user ID, the signature σ, and the message m that are transmitted from the biometric-based signature generation apparatus 120.

(Step 3) Read out the verification key vk corresponding to the user ID transmitted from the biometric-based signature generation apparatus 120 from the storge part of the verification apparatus 140, and verify the signature σ for the message m using said verification key vk.

The verification apparatus 140 transmits a verification result of the signature σ to the terminal in a store or facility (which may be the biometric-based signature generation apparatus 120 of FIG. 2, a transmission source of the signature σ). When the verification result of the signature σ is successful, the terminal in a store or a facility terminal transmits the second biometric w′ to the biometric-based signature generation apparatus 120. If the verification result of the signature σ is successful, the terminal in the store or facility may provide a predetermined service, such as electronic payment, to the user who provided the second biometric information w′ at the biometric-based signature generation apparatus 120, thereby realizing an empty handed payment.

In FIG. 2, the biometric-based key generation apparatus 110 and the biometric-based signature generation apparatus 120 are each shown as one unit simply for drawing convenience, but more than one biometric-based signature generation apparatus 120 may be provided in a case of a terminal in a store, etc. The biometric-based key generation apparatus 110 is used to generate a user's biometric signature, and the biometric-based signature generation apparatus 120 is used to generate a user's signature. The biometric-based key generation apparatus 110 may be a user's terminal or a terminal provided in a store. The user ID identification apparatus 130 may be implemented as a server apparatus and may be configured to be connected to a plurality of biometric-based key generation apparatus 110 and a plurality of biometric-based signature generation apparatuses 120 by one or more networks (communication lines).

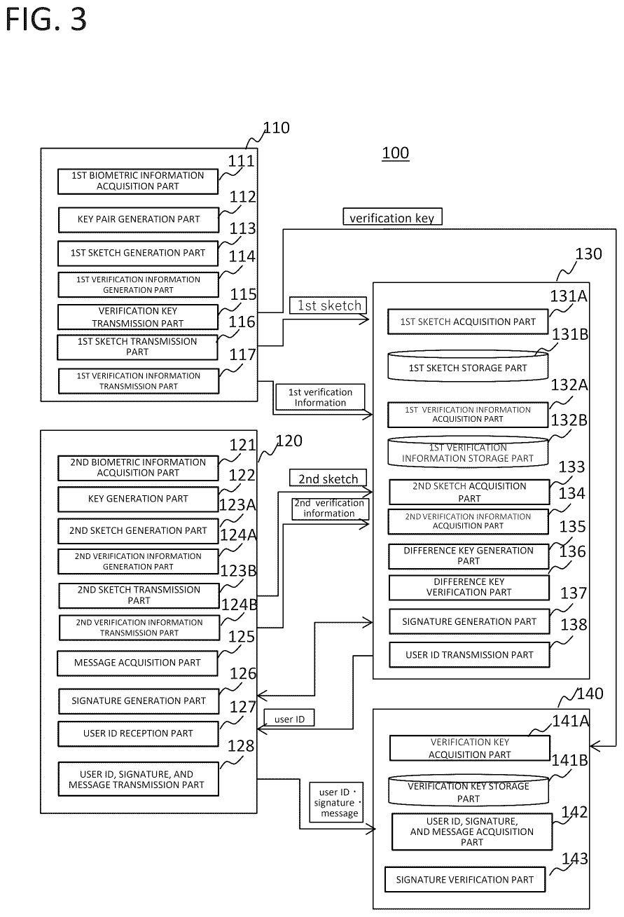

FIG. 3 illustrates an example of a functional configuration of each apparatus of the signature system 100 described with reference to FIG. 2.

The biometric-based key generation apparatus 110 includes a first biometric information acquisition part 111, a key pair generation part 112, a first sketch generation part 113, a first verification information generation part 114, a verification key transmission part 115, a first sketch transmission part 116 and a first verification information transmission part 117.

The first biometric information acquisition part 111 acquires the first biometric information w. The first biometric information w may be, for example, feature information extracted from biometric information (digital data) acquired by a camera, sensor, or the like. The first biometric information w may be binary data or a vector with n real-valued elements (n-dimensional real vector).

The key pair generator 112 generates a first signing key x (let x be the sk in Equation (1)), which is a secret key, and a verification key vk, which is a public key, according to the key generation algorithm in Equation (1).

The first sketch generator 113, for example, generates the first sketch s by combining an encoded key Enc(x), which is obtained by applying an encoding function Enc to the first signing key x, and the first biometric information w.

$$s := Enc ( x ) + w \qquad ( 13 )$$

In Equation (13), the operation + may be −. Alternatively, it may be a bit-wise exclusive OR operation (bit-wise exclusive OR), etc., depending on the encoding function. For example, if the first biometric w is binary data and Enc(x) is binary data, the right side of Equation (13) may be a bitwise exclusive OR of the first biometric w and Enc(x). If the first biometric w is an n-dimensional vector, the right-hand side of Equation (13) may be a vector addition (or vector subtraction) of the first biometric w and Enc(x).

The encoding function Enc converts a plaintext m in an information source space to a code c. A decoding function Dec converts the code c back to plaintext m.

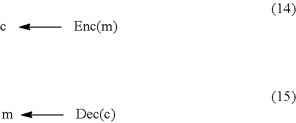

For any plaintext m contained in the information source space whose difference from the code c′ is within a correction range (capability), for example, the following Equation must hold.

$$m = Dec ( {c}^{′} ) \qquad ( 16 )$$

In the following, a linear code is used, where linearity is defined as below holds.

### Linearity:

$$Enc ( m 1 ) + Enc ( m 2 ) \qquad ( 17 )$$

is a code word of m1+m2, and

$$m 1 + m 2 = Dec ( Enc ( m 1 ) + Enc ( m 2 ) ) \qquad ( 18 )$$

In Equation (18), “+” on the left and right sides need not be the same operation.

As for coding, an error correction coding (e.g., Hamming code, BCH (Bose-Chaudhuri-Hocquenghem) code, RS (Reed-Solomon) code, LDPC (low-density parity-check) code, etc.) may be used. Alternatively, a lattice coding may be used, such as integer lattice, triangular lattice, and more complex lattice (reference may be made to Reference Literature 2, etc.).

The first verification information generation part 114 applies the one-way function h to the first signing key x to generate the first verification information vi=h (x), wherein the first signing key x cannot be leaked from the first verification information vi.

The one-way function h is easy to compute on input or from one to the other, but the inverse is computationally hard. The one-way function includes a function that provides a discrete logarithm problem, a cryptographic hash function or the like.

For example, it is difficult to find an integer x(0<x<p) such that h (x)=g″ (given an element of a multiplication group, y=h (x)=g^{x}) in the multiplication group Fq*=<g> (g is a generator) of a finite prime field Fq where q is a prime number (discrete logarithm problem, DLP). In this case, the one-way function is given by h (x)=g and satisfies the following additive homomorphism:

$$h ( {x}^{′} ) * h ( x - {x}^{′} ) = h ( x ) \qquad ( 19 )$$

Also, for rational points Y and G on an elliptic curve E(Fq) on a finite field Fq, it is difficult to find an integer x (0<x<1:1 is a rank of base point G) from Y=[x] G (scalar times: point G is added x times repeatedly) (Elliptic Curve DLP, ECDLP)). A one-way function h is given by h (x)=[x] G. Rational points on an elliptic curve form an additive group whose identity element is a point at infinity O. That is, it satisfies the following relation of the additive homomorphism.

$$[ {x}^{′} ] G + [ x - {x}^{′} ] G = [ x ] G ( h ( {x}^{′} ) + h ( x - {x}^{′} ) = h ( x ) ) \qquad ( 20 )$$

A homomorphic ideal lattice hash function or the like may be used as the one-way function h.

The verification key transmission part 115 transmits the verification key vk to the verification apparatus 140. The verification information vk may be transmitted together with a user ID.

The first sketch transmission part 116 transmits the first sketch s to the user ID identification apparatus 130. The first sketch s may be transmitted together with the user ID.

The first verification information transmitter 117 transmits the first verification information vi to the user ID identification apparatus 130. The first verification information vi may be transmitted together with the user ID.

The biometric-based signature generation apparatus 120 includes a second biometric information acquisition part 121, a key generation part 122, a second sketch generation part 123A, a second verification information generation part 124A, a second sketch transmission part 123B, a second verification information transmission part 124B, a message acquisition part 125, a signature generation part 126 and user ID reception part 127, and user ID, signature, and message transmitting part 128.

The second biometric information acquisition part 121 acquires the second biometric information w′ for signature generation. The key generation part 122 generates the second signing key x′ (the second signing key x′ and the second verification key vk′). The second biometric information w′ that the second biometric information acquisition part 121 acquires from the sensor is assumed to be the same modality as the first biometric information w acquired by the first biometric information acquisition part 111 of the biometric-based key generation apparatus 110. A sensor of the second biometric information acquisition part 121 and a sensor of the first biometric information acquisition part 111 of the biometric-based key generation apparatus 110 may be the same model and the same performance, and the same software may be used for feature extraction.

The second sketch generation part 123A generates the second sketch s′ by combining an encoded key Enc (x′) obtained by applying the encoding function to the second signing key x′ and the second biometric information w′.

The second verification information generation part 124A applies a homomorphic one-way function to the second signing key x′ to generate the second verification information vi′=h (x′). The second signing key x′ cannot be compromised from the second verification information vi′.

The second sketch transmission part 123B transmits the second sketch s′ to the user ID identification apparatus 130.

The second verification information transmission part 124B transmits the second verification information vi′ to the user ID identification apparatus 130.

The message acquisition part 125 acquires a message m to be signed. The message may be an electronic document such as a payment at a store or facility.

The signature generation part 126 generates a signature σ for the message m.

The user ID receiver 127 receives a user ID transmitted from the user ID identification apparatus 130.

The user ID, signature, and message transmission part 128 transmits the user ID, signature, and message to the verification apparatus 140.

The user ID identification apparatus 130 includes a first sketch acquisition part 131A, a first sketch storage part 131B, a first verification information acquisition part 132A, a first verification information storage part 132B, a second sketch acquisition part 133, a second verification information acquisition part 134, a difference key generation part 135, a difference key verification part 136, a signature generation part 137 and a user ID transmission part 138.

The first sketch acquisition part 131A acquires the first sketch transmitted from the biometric-based key generation apparatus 110 and registers it with the user ID in the first sketch storage part 131B. The first verification information acquisition part 132A acquires the first verification information transmitted from the biometric-based key generation apparatus 110 and registers it in the first verification information storage part 132B, in correspondence with the user ID. The first sketch and the first verification information registered in the first sketch storage part 131B and the first verification information storage part 132B may be registered at respective fields of a record corresponding to a user ID in a database (DB) table. In this case, each record (row) includes fields (column) for the user ID, the first sketch, and the first verification information. The user ID may be a row number of the record in the DB table.

The second sketch acquisition part 133 acquires the second sketch s′ transmitted from the biometric-based signature generation apparatus 120. The second verification information acquisition part 134 acquires the second verification information vi′ transmitted from the biometric-based signature generation apparatus 120.

The difference key generation part 135 restores the difference key Δ[k] from the kth (e.g., kth row) first sketch s[k] (=Enc (x [k])+w[k]) registered in the first sketch memory 131B and the first verification information memory 132B, and the second sketch s′. When the recovery function Rec is composed of a decoding function Dec corresponding to the encoding function Enc, the following holds.

$$\begin{matrix}Δ [ k ] = Rec ( s [ k ] , {s}^{′} ) = Dec ( s [ k ] = {s}^{′} ) \\ = Dec ( Enc ( x [ k ] ) + w [ k ] - ( Enc ( {x}^{′} ) + {w}^{′} ) ) \\ = Dec ( Enc ( x [ k ] - {x}^{′} ) + ( w [ k ] - {w}^{′} ) )\end{matrix} \qquad ( 21 )$$

When the difference (distance) between the first biometric w[k] used for the first sketch s[k] in the kth (kth row) (=Enc(x [k])+w[k]) and the second biometric w′ used in the first sketch is within a correction range (error correction range), then

$$Δ [ k ] = x [ k ] - {x}^{′} \qquad ( 22 )$$

The difference key verification part 136 computes h(Δ[k]) and checks whether h(Δ[k]) multiplied with vi′ satisfies the following equation for the kth first verification information vi[k].

$${vi}^{′} * h ( Δ [ k ] ) = vi [ k ] \qquad ( 23 )$$

If Equation (23) holds for the kth first sketch s[k] and the first verification information vi[k], the difference key verification part 136 takes an ID of the kth entry as the user ID of the user of the second biometric w′. The user ID transmission part 138 transmits the user ID to the biometric-based signature generation apparatus 120.

If Equation (23) does not hold for any of k=1 to N, the difference key verification part 136 fails find the user ID and may interrupt a process (alternatively may output an error message).

When the distributed signature generation process is to be performed with the signature generation part 126 of the biometric-based signature generation apparatus 120, the signature generation part 137 is configured to generate a distributed signature. When the signature generation part 126 of the biometric-based signature generation apparatus 120 generates a biometric-based signature by itself, the signature generation part 137 is not required.

The verification apparatus 140 includes a verification key acquisition part 141A, a verification key storage part 141B, a user ID, signature, and message acquisition part 142, and a signature verification part 143.

The verification key acquisition part 141A receives the verification key transmitted from the biometric-based key generation apparatus 110 and registers it with the user ID in the verification key storage part 141B.

The user ID, signature, and message acquisition part 142 receives the user ID, signature σ, and message m transmitted from the biometric-based signature generation apparatus 120.

The signature verification part 143 obtains the verification key vk corresponding to the user ID from the verification key storage part 141B and verifies correctness of a set of the message m and the signature σ using the verification key vk.

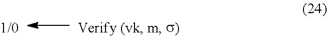

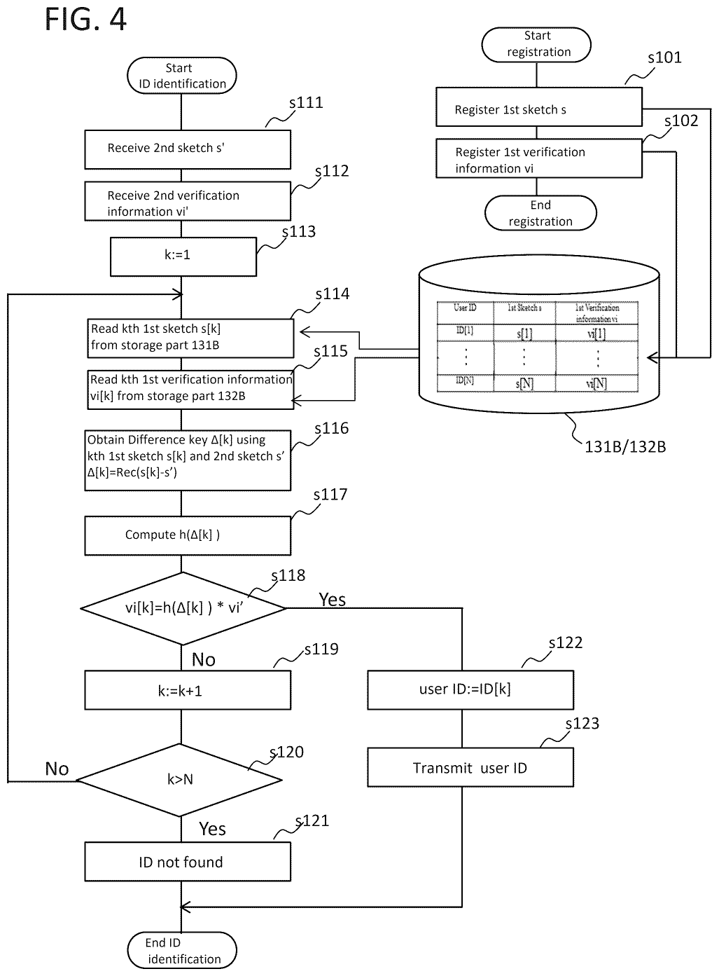

FIG. 4 illustrates a process flow of the user ID identification apparatus 130. In the registration process, the first sketch acquisition part 131A acquires the first sketch s transmitted from the biometric-based key generation apparatus 110 and registers it with the user ID in the first sketch storage part 131B (Step s101).

The first verification information acquisition part 132A acquires the first verification information transmitted from the biometric-based key generation apparatus 110 and registers it in the first verification information storage part 132B, in correspondence with the user ID (Step s102). The first sketch storage part 131B and the first verification information storage part 132B may constitute columns (fields) of a database table. The user ID may be a user ID of the user used when the user longs in the biometric-based key generation apparatus 110, or the user ID of the user used when the user logs in an application that accesses the user ID identification apparatus 130 from the biometric-based key generation apparatus 110. The user ID may be an address or terminal ID of the biometric-based key generation apparatus 110. The user ID identification apparatus 130 may receive a plurality of pairs of first sketch s and first verification information vi generated for a plurality of users by a plurality of biometric-based key generation apparatus 110 and register them for each user ID of a plurality of users. In this case, the biometric-based key generation apparatus 110 may be a terminal possessed by each user. Alternatively, a single biometric-based key generation apparatus 110 may be used to generate the first signing key and the verification key and a set of the first sketch and the first verification information for each of a plurality of users. The biometric-based key generation apparatus 110 may transmit the verification key and the user ID, a set of the first sketch and the first verification information and the user ID to the user ID identification apparatus 130.

The user ID identification process receives the second sketch and the second verification information from the biometric-based signature generation apparatus 120 (Steps s111 and s112).

The first sketch s[k] of the kth (kth row) and the first verification information vi[k] are read from the storage parts 131B and 132B (Steps s114 and s115). The first sketch s and the first verification information vi of the kth row stored in the storage part in a table form are denoted by s[k] and vi[k] for convenience.

The difference key Δ[k] is restored by the function Rec ( ) with the kth first sketch s[k] and the second sketch s′ inputted thereto as input arguments (Step s116).

$$Δ [ k ] := Rec ( s [ k ] , {s}^{′} ) \qquad ( 25 )$$

If a difference (distance) between the first biometric w[k] used to generate the kth first sketch s[k] (=Enc (x [k])+w[k]) and the second biometric w′ is within a correction range (error correction range), the following holds.

$$Δ [ k ] = x [ k ] - {x}^{′}$$

The homomorphic one-way function h is applied to the difference key Δ[k] to obtain h(Δ[k]) (Step s117).

Check if the following holds (Step s118).

$$vi [ k ] = h ( Δ [ k ] ) * {vi}^{′} \qquad ( 26 )$$

$$i . e . , h ( x [ k ] ) = h ( x [ k ] - {x}^{′} ) * h ( {x}^{′} ) \qquad ( 27 )$$

If Equation (27) holds (Yes branch of Step s118), the kth user ID (ID[k]) is used as the user ID of the user corresponding to the second biometric information w′ (Step s122), and the user ID is transmitted to the biometric-based signature generation apparatus 120 (Step s123).

In Steps s113 to s120, if for every loop variable k from 1 to N, the judgment result in Step s118 is No (Equation (27) does not hold), an error may be notified as the user ID corresponding to the second biometric information w′ is not found (Step s121), or the process may be interrupted. In that case, error notification may be made, the user's second biometric information w′ may be acquired again and the user ID identification process of steps s113 to s120 may be retried, and the process may be interrupted when the retry number exceeds a predetermined number.

It is noted that in face recognition, etc., a feature(s) may be represented as a vector in Euclidean space, and judgement of closeness between two pieces of biometric information may be made using the Euclidean distance (L2 distance). In case where biometric information is an n-dimensional vector (n is an integer greater than or equal to 2), the Euclidean distance d (w, w′) (L2 norm) may be calculated as the distance between the first biometric information w and the second biometric information w′.

For example, from

$$s := Enc ( x ) + w \qquad ( 28 )$$

$${s}^{′} := Enc ( {x}^{′} ) + {w}^{′} \qquad ( 29 )$$

$$w - {w}^{′} = s - Enc ( x ) - ( {s}^{′} - Enc ( {x}^{′} ) = s - {s}^{′} - Enc ( Δ ) \qquad ( 30 )$$

$$d ( w , {w}^{′} ) = ‖ w - {w}^{′} ‖ \qquad ( 31 )$$

If the Euclidean distance d (w, w′) exceeds a predefined threshold, it is determined that the user of the second biometric information w′ is not the same person as the user of the kth biometric information w used to generate the kth first sketch s[k]. By using the judgment based on Euclidean distance, the identity of the user can be confirmed with the same level of accuracy as biometric authentication. If the biometric information is binary data, the distance between the first biometric information w and the second biometric information w′ may be the Hamming distance or the like.

The following describes a biometric distributed signature generation scheme.

Key Generation: The biometric-based key generation apparatus 110 generates the first sketch s and the verification key vk based on the first biometric information w and a security parameter κ.

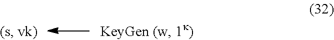

As an example, the first signing key (private key) x and the verification key (public key) vk are generated by entering security parameter κ.

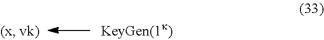

The user's first biometric information w and the first signing key x are inputted to a linear sketch generation algorithm to generate the first sketch s

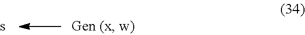

The first sketch s may be termed as a helper key (hk).

Signing: By exchanging information between a signature generation part of a first apparatus (e.g., the signature generation part 126 of the biometric-based signature generation apparatus 120) that acquires the second biometric w′ and a signature generation part of a second apparatus (signature generation part 137 of the user ID identification apparatus 130) that holds the first sketch s, the signature σ for the document Mis generated. For example, the first apparatus generates the second signing key x′ and generates the second sketch s′ by

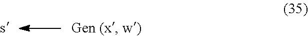

The first apparatus transmits the second sketch s′ to the second apparatus, which restores the difference key Δ between the first signing key x and the second signing key x′ from a difference between the first sketch s and the second sketch s′. The signature generation part of the second apparatus (e.g., the signature generation part 137 of the user ID identification apparatus 130) generates a second distributed signature with the difference key Δ. The signature generation part of the first apparatus (e.g., the signature generation part 126 of the biometric-based signature generation apparatus 120) generates a first distributed signature with the second signing key x′. The signature generation part of the first apparatus (e.g., the signature generation part 126 of the biometric-based signature generation apparatus 120) may combine the first distributed signature by the second signing key x′ and the second distributed signature by the difference key Δ to generate a signature that is equivalent to a signature for the message m generated using the first signing key x. Alternatively, using a key homomorphism function Khom (Khom corresponds to SignShift in Non-Patent Literature 1, or in part to the Adapt algorithm in Reference Literature 7) for the second distributed signature σ′ by the difference key Δ,

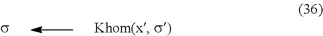

where Δ+x′=(x−x′)+x′=x,
a signature σ that is equivalent to a signature for the message m generated using the first signing key x may be generated.

Verification: The verification apparatus 140 verifies whether a set of the message m and the signature σ is correct using the verification key vk. If a verification result is accepted (success), 1 may be returned, and if not accepted (failure), 0 may be returned.

In the present disclosure, when applied to the above described biometric distributed signature generation scheme, the biometric-based key generation apparatus 110 may generate the verification key vk, the first sketch s as well as the first verification information vi, may transmit the verification key vk to the verification apparatus 140, and transmit the first sketch s and the first verification information vi to the user ID identification apparatus 130. The first verification information vi may be a verification key vk generated using the VKGen ( ) function that generates the verification key vk from the first signing key x.

$$vk = VKGen ( x ) \qquad ( 37 )$$

In signature generation (signing phase), in addition to acquisition of the second biometric information w′, generation of the second signing key x′, and generation of the second sketch s′, the biometric-based signature generation apparatus 120 may generate the second verification information vi′, and may transmit the second sketch s′ and the second verification information vi′ to the user ID identification apparatus 130. The second verification information vi′ may be a verification key vk′ generated by

$${vk}^{′} = VKGen ( {x}^{′} ) \qquad ( 38 )$$

The biometric-based signature generation apparatus 120 generates a first distributed signature for the message m using the second signing key x′.

The user ID identification apparatus 130 generates a difference key Δ[k] based on a difference between kth first sketch s[k] out of N number of the first sketches registered in the storage part (table) and the second sketch s′ and checks if the following holds.

$$vi [ k ] = h ( Δ [ k ] ) * {vi}^{′} \qquad ( 39 )$$

If the above holds, the kth ID[k] registered in the storage part (ID[k] may be k) is set as a user ID.

The signature generation part 137 of the user ID identification apparatus 130 generates a second distributed signature for the message m using the difference key Δ[k] and transmits it to the biometric-based signature generation part 120.

The biometric-based signature generation apparatus 120 combines the first and second distributed signatures to generate a signature equivalent to a signature for the message generated using the first signing key x.

The biometric-based signature generation apparatus 120 receives the user ID identified by the user ID identification apparatus 130 and transmits the user ID, the signature and the message m to the verification apparatus 140.

The following describes a Schnorr signature scheme as an example of distributed signature generation scheme between the signature generation part 126 of the biometric-based signature generation apparatus 120 and the signature generation part 137 of the user ID identification apparatus 130. First, an overview of a Schnorr signature algorithm typically may include the following steps (phases).

Key generation: p and q are odd prime numbers q|(p−1) (where q is a divisor of p−1), g is a generator of a rank q of a multiplication group Zₚ*, i.e.,

$$g \hat{} q ≡ 1 ( mod p ) \qquad ( 40 )$$

where mod is a modulo operator.

Choose a secret key x uniformly at random.

x←^{R}Z_{q} (where Z_{q}=Z/_{q}Z: is a set of integers between 0 and q) (41)

The symbol “←^{R}” indicates a uniform random selection from an information source (in this case, Zq).

Compute a public key vk.

$$vk = g \hat{} x mod p \qquad ( 42 )$$

where \hat{ } is a power operator.

A public key may be p, q, g, and vk. However, p, q, and g may be shared by each apparatus as common parameters, and the public key may be vk.

### Signing:

A nonce k is chosen uniformly at random.

$$k ← {}_{}^{R} {Z}_{q}^{} \qquad ( 43 )$$

$$r = g \hat{} k mod p \qquad ( 44 )$$

$$e = H ( r , m ) \qquad ( 45 )$$

$$y = k - e * x mod q \qquad ( 46 )$$

Signature: σ=(e, y)

It is noted that the hash function H (r, m) computes a hash value e for a value of r and m concatenated.

### Verification:

A function Verify (vk, m, σ) receives vk (=g\hat{ }x mod p: public key), the signature σ=(e, y) and the message m as input arguments, computes

$${r}^{′} = ( g \hat{} y ) ( vk \hat{} e ) mod p \qquad ( 47 )$$

and if e=H(r′, m) holds, Verify returns 1 (if not, returns 0 (not accepted).

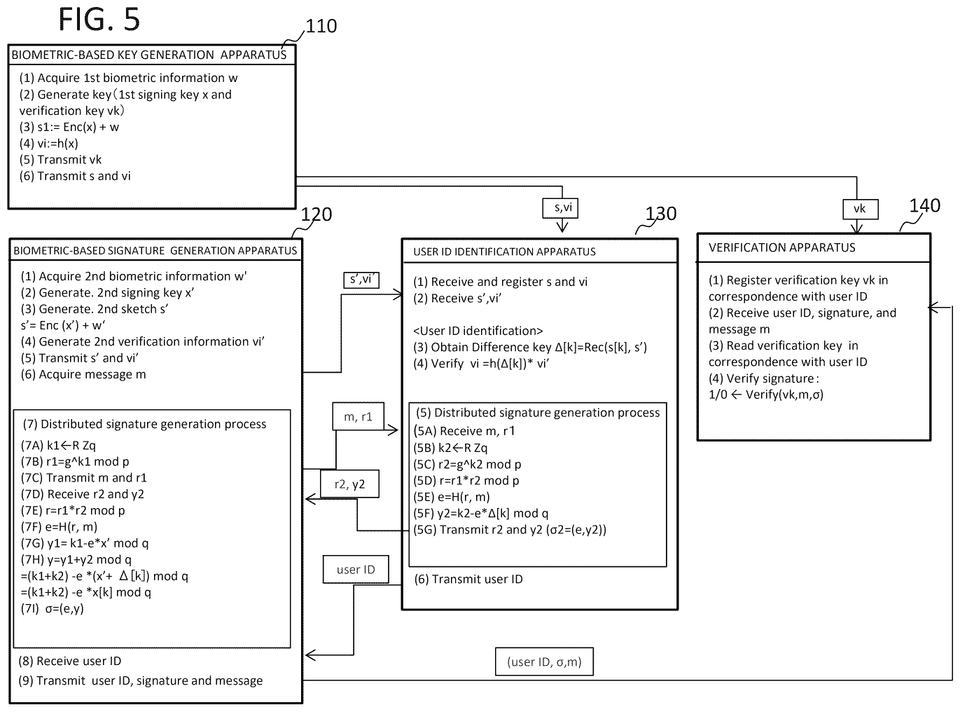

FIG. 5 illustrates an example of a process flow of two-party distributed signature generation (Two-Party Schnorr signature) between the biometric-based signature generation apparatus 120 and the user ID identification apparatus 130. For more detailed information on a two-party distributed Schnorr signature algorithm, reference may be made to, for example, Reference Literature 3. Numbers in parentheses within each apparatus in FIG. 5 are process numbers.

The biometric-based key generation apparatus 110 may perform the following processes:
(Step 1) The first biometric acquisition part 111 acquires first biometric w of a user.
(Step 2) The key pair generator 112 selects a first signing key x uniformly at random (x←^{R}Fₙ*). The key pair generator 112 of the biometric-based key generation apparatus 110 generates a verification key vk corresponding to the first signing key x (vk=g\hat{ }x). The pair of the first signing key x and the verification key vk may be generated in a single key generation procedure.
(Step 3) The first sketch generator 113 generates a first sketch s (=Enc(x)+w) using an encoded key value c (=Enc(x)) which is obtained by applying the encoding function Enc to the first signing key x, and the first biometric information w.
(Step 4) The first verification information generation part 114 generates first verification information vi=H (x) from the first signing key x.
(Step 5) The first verification key transmission part 115 transmits the verification key vk to the verification apparatus 140. The verification key vk may be transmitted together with a user ID to the verification apparatus 140.
(Step 6) The first sketch transmission part 116 transmits the first sketch s to the user ID identification apparatus 130, and the first verification information transmission part 117 transmits the first verification information vi to the user ID identification apparatus 130.

The user ID identification apparatus 130 may perform the following processes:
(Step 1) The first sketch acquisition part 131A receives the first sketch s and stores it in the first sketch storage part 131B. The first verification information acquisition part 132A receives the first verification information vi and stores it in the first verification information storage part 132B. In FIG. 5, the reception and registration of the first sketch s and the first verification information vi are described as a single processing step simply for the convenience of drawing, but as a matter of course, the reception step and the registration step can be made separate. The first sketch s and the first verification information vi, may, as a matter of course, be stored in respective columns of a single record corresponding to a user ID.

When generating a biometric-based signature, the biometric-based signature generation apparatus 120 may perform the following processes:
(Step 1) The second biometric information acquisition part 121 acquires second biometric information w′.
(Step 2) The key generation part 122 chooses a second signing key x′ uniformly at random (Δ←^{R}Zq) (Δ∈[0, q−1]).
(Step 3) The second sketch generation part 123A generates a second sketch s′ (=Enc (x′)+w′) using the second signing key x′ and the second biometric w′.
(Step 4) The second verification information generation part 124A generates second verification information vi′(=h(x′)) from the second signing key x′.
(Step 5) The second sketch transmission part 123B transmits the second sketch s′ to the user ID identification apparatus 130. The second verification information transmission part 124B transmits the second verification information vi′ to the user ID identification apparatus 130. In FIG. 5, transmission of the second sketch s′ and the second verification information vi′ is described as a single step simply for the convenience of drawing, but the second sketch s′ and the second verification information vi may as a matter of course be transmitted as separate steps.

The user ID identification apparatus 130 may perform the following processes following the above-described Step 1:
(Step 2) The second sketch acquisition part 133 receives the second sketch s′ transmitted from the biometric-based signature generation apparatus 120. The second verification information acquisition part 134 receives the second verification information vi′ transmitted from the biometric-based signature generation apparatus 120.
(Step 3) For the second sketch s′ and the second verification information vi′, the difference key generation part 135 restores a difference key Δ[k] using the first sketch s[k] and the second sketch s′, where the first sketch s[k] is a first sketch of the kth (1≤k≤N) set of the first sketch (s [k]) and the first verification information (vi [k]), out of N sets of first sketches s and first verification information vi that are respectively stored (registered) in the first sketch storage part 131B and the first verification information storage part 132B).

$$Δ [ k ] = Rec ( s [ k ] , {s}^{′} ) = Dec ( s [ k ] - {s}^{′} ) = x [ k ] - {x}^{′} mod p \qquad ( 48 )$$

$$where s [ k ] = Enc ( x [ k ] ) + w [ k ] \qquad ( 49 )$$

The difference key verification part 136 checks if

$$vi = h ( Δ [ k ] ) * {vi}^{′} \qquad ( 50 )$$

i.e.,

$$h ( x [ k ] ) = h ( x [ k ] - {x}^{′} ) * h ( {x}^{′} ) \qquad ( 51 )$$

holds.

If the above holds, an ID[k] of the kth set is identified as the user ID of the user of the second biometric information w′, because a difference (distance) between the first biometric information w used to generate the first sketch s[k] stored as the kth set in the first sketch storage part 131B and the second biometric information w′ used to generate the second sketch s′ is within an error correction range.

It is noted that the first verification information vi may be the verification information vk=g\hat{ }x mod p corresponding to the first signing key x. The second verification information vi′ may be the verification information vk′=g\hat{ }x′ mod p corresponding to the second signing key x′. The first verification information vi[k] stored as the kth set in the first verification information storage 132B, when the corresponding first signing key x is expressed as x[k], is given as follows.

$$vi [ k ] = g \hat{} x [ k ] mod p \qquad ( 52 )$$

In this case, the following holds

$$h ( Δ [ k ] ) * {vi}^{′} = g \hat{} ( x [ k ] - {x}^{′} ) * g \hat{} {x}^{′} mod p = g \hat{} x [ k ] mod p \qquad ( 53 )$$

and thus

$$vi [ k ] = h ( Δ [ k ] ) * {vi}^{′} \qquad ( 54 )$$

The biometric-based signature generation apparatus 120 may perform the following processes after the above-described Step 6.
(Step 7) The signature generation part 126 performs distributed signature generation. The distributed signature generation includes following steps:
(Step 7A) The signature generation part 126 chooses a first random number k1 uniformly at random (k1←^{R}Z_{q}) (k1∈[0,q−1]).
(Step 7B) The signature generation part 126 computes a value r1 by multiplying the generator g by the first random number k1.

$$r 1 = g \hat{} k 1 mod p \qquad ( 55 )$$

(Step 7C) The signature generation part 126 transmits the message m and r1 to the signature generation part 137 of the user ID identification apparatus 130.

(Step 7D) The signature generation part 126 receives r2 and y2 transmitted from the signature generation part 137 of the user ID identification apparatus 130.

(Step 7E) The signature generation part 126 computes a value r by multiplying r2 (=g\hat{ }k2 mod p) received from the signature generation part 137 of the user ID identification apparatus 130 by r1 (=g\hat{ }k1 mod p) that the signature generation part 126 has computed.

$$r = r 1 * r 2 mod p = g \hat{} ( k 1 + k 2 mod q ) mod p \qquad ( 56 )$$

(Step 7F) The signature generation part 126 inputs r and the message m to the hash function H to compute a hash value e.

$$e = H ( r , m ) \qquad ( 57 )$$

(Step 7G) The signature generation part 126 computes

$$y 1 = k 1 - e * {x}^{′} mod q \qquad ( 58 )$$

(Step 7H) The signature generation part 126 computes y by combining y1 and y2.

$$\begin{matrix}y = y 1 + y 2 = k 1 - e * {x}^{′} mod q + k 2 - e * Δ [ k ] mod q \\ = ( k 1 + k 2 ) = e * ( {x}^{′} + Δ [ k ] ) mod q \\ = ( k 1 + k 2 ) - e * ( {x}^{′} + x [ k ] - {x}^{′} ) mod q \\ = ( k 1 + k 2 ) - e * x [ k ] mod q\end{matrix} \qquad ( 59 )$$

where x[k] indicates a first signing key x used to generate the first sketch s[k] in the user ID identification apparatus 130.
(Step 71) In the above, the signature generation part 126 of the biometric-based signature generation apparatus 120 generates (completes) the signature σ=(e, y) for the message m with the signing key x′+Δ[k] (=first signing key x[k]).
(Step 8) The user ID reception part 127 receives the user ID identified by the user ID identification apparatus 130.
(Step 9) The user ID, signature, and message transmission part 128 transmits the user ID, the signature σ, and the message m to the verification apparatus 140.

The user ID identification apparatus 130 may perform the following step after the above described Step 4.
(Step 5) The signature generation part 137 communicates with the signature generation part 126 of the biometric-based signature generation apparatus 120 to perform the following distributed signature generation processing.
(Step 5A) The signature generation part 137 receives the message m and r1 from the signature generation part 126 of the biometric-based signature generation apparatus 120.
(Step 5B) The signature generation part 137 uniformly randomly selects a second random number k2 (k2←^{R}Z_{q} (k2∈[0,q−1])).
(Step 5C) The signature generation part 137 computes a value r2 by raising the generator g to the power of the second random number k2.

$$r 2 = g \hat{} k 2 mod p \qquad ( 60 )$$

(Step 5D) The signature generation part 137 computes a value r by multiplying r2 by r1 transmitted from the biometric-based signature generation apparatus 120.

$$r = r 1 * r 2 mod p \qquad ( 61 )$$

(Step 5E) The signature generation part 137 inputs r and the message m to the hash function H to compute a hash value e:

$$e = H ( r , m ) ( ∈ {Z}_{q}^{*} : the set of integers {Z}_{q} and prime to q ) \qquad ( 62 )$$

(Step 5F) The signature generation part 137 computes

$$y 2 = k 2 - e * Δ [ k ] mod q \qquad ( 63 )$$

using a product of e and the difference key Δ[k] and the second random number k2.

Thus, using e and y2, a distributed signature σ2=(e, y2) is obtained. σ2=(e, y2) may also be referred to as a second distributed signature.
(Step 5G) The signature generation part 137 transmits r2 obtained from equation (60) and y2 (the second element of the second distributed signature σ2=(e, y2)) obtained from Equation (63) to the biometric-based signature generation apparatus 120.
(Step 6) The user ID transmission part 138 transmits the user ID to the biometric-based signature generation apparatus 120.

The verification apparatus 140 may perform the following processes.
(Step 1) The verification key acquisition part 141A receives the verification key vk transmitted from the biometric key generation apparatus 110 and stores (registers) it in the verification key storage part 141B corresponding to the user ID.

It is noted that the user ID may be set common between the verification key storage part 141B and the user ID in the user ID identification apparatus 130.
(Step 2) The user ID, signature, and message acquisition part 142 receives the user ID, the signature σ=(e, y), and the message m.
(Step 3) The signature verification part 143 reads the verification key vk corresponding to the user ID from the verification key storage part 141B and uses the verification key vk to verify correctness of the set of the signature σ=(e, y) and the message m. More specifically, the signature verification part 143 computes a value r′ by multiplying a value obtained by raising the generator g to the power of y and a value obtained by raising the public key vk corresponding to the user ID to the power of e.

$${r}^{′} = ( g \hat{} y ) * ( vk \hat{} e ) mod p \qquad ( 64 )$$

Then, the signature verification part 143 computes a hash value of r′ and the message m concatenated.

$$H ( {r}^{′} , m ) \qquad ( 65 )$$

$$If e = H ( {r}^{′} , M ) \qquad ( 66 )$$

holds, Verify (v, M, σ) in the signature verification part 143 returns 1 (accepted), and if not hold, returns 0 (rejected).

Two factors in a right side of Equation (64) are respectively rewritten as follows.

$$g \hat{} y = g \hat{} \{ ( k 1 + k 2 - e * ( {x}^{′} + Δ ) ) mod q \} mod p \qquad ( 67 )$$

$$vk \hat{} e = g \{ ( x * e ) mod q \} mod p \qquad ( 68 )$$

From above, r′ in Equation (64) is given as below.

$${r}^{′} = g \hat{} \{ ( k 1 + k 2 - e * ( {x}^{′} + Δ ) + e * x ) mod q \} mod p \qquad ( 69 )$$

$$where x = Δ + {x}^{′} mod q \qquad ( 70 )$$

Thus, the right-hand side of Equation (64) is expressed as below:

$${r}^{′} = g \hat{} \{ ( k 1 + k 2 ) mod q \} mod p \qquad ( 71 )$$

That is, r′ coincides with r in Equation (61).

Therefore,

$$H ( {r}^{′} , m ) = H ( r , m ) = e \qquad ( 72 )$$

holds, and Verify (v, M, σ) returns 1 (accept).

On the other hand, if

$$x \neq {x}^{′} Δ mod q \qquad ( 73 )$$

then r′#r, and therefore,

$$H ( {r}^{′} , m ) \neq e \qquad ( 74 )$$

and Verify (v, M, σ) returns 0 (rejection).

For the purpose of enhancing security, a zero-knowledge proof (non-interactive zero-knowledge: NIZK) that the first random number k1 is known may be performed from the biometric-based signature generation apparatus 120 to the user ID identification apparatus 130. In this case, the biometric-based signature generation apparatus 120 and the user ID identification apparatus 130 share a proof generation key and a proof verification key. For example, in FIG. 5, the signature generation part 126 of the biometric-based signature generation apparatus 120, which is a prover, computes r1 using the first random number k1 (Step 7B of the biometric-based signature generation apparatus 120 in FIG. 5), and then generates a proof (NIZK proof) π1 from an specific example of a proposition to be proven (instance: knowing the first random number k1) and an evidence (witness) that the proposition is correct, and may transmit an instance (r1) and proof π1 to a verifier, i.e., the user ID identification apparatus 130. The user ID identification apparatus 130, which is the verifier, may verify the proof π1 using the proof verification key on receipt of the instance (r1) and the proof π1.

A non-interactive zero-knowledge proof may be performed from the user ID identification apparatus 130 to the biometric-based signature generation apparatus 120 to prove that the second random number k2 is known. For example, in FIG. 5, the signature generation part 137 of the user ID identification apparatus 130, which is a prover, computes r2 using the second random number k2 (Step 5C of the user ID identification apparatus 130 in FIG. 5), and then generates a proof π2 based on a specific example of a proposition to be proven (an instance: knowing the second random number k2) and an evidence that the proposition is correct, and then transmit the instance (r2) and the proof π2 to the verifier, the biometric-based signature generation apparatus 120. The verifier, the biometric-based signature generation apparatus 120, receives the instance (r2) and the proof π2 and then verifies proof π2 using the proof verification key. The biometric-based signature generation apparatus 120 may decommit the instance (r2) and the proof π2, and the user ID identification apparatus 130 may verify proof π1 after the commitment has been released (decommitted) (reference may be made to Reference Literature 4).

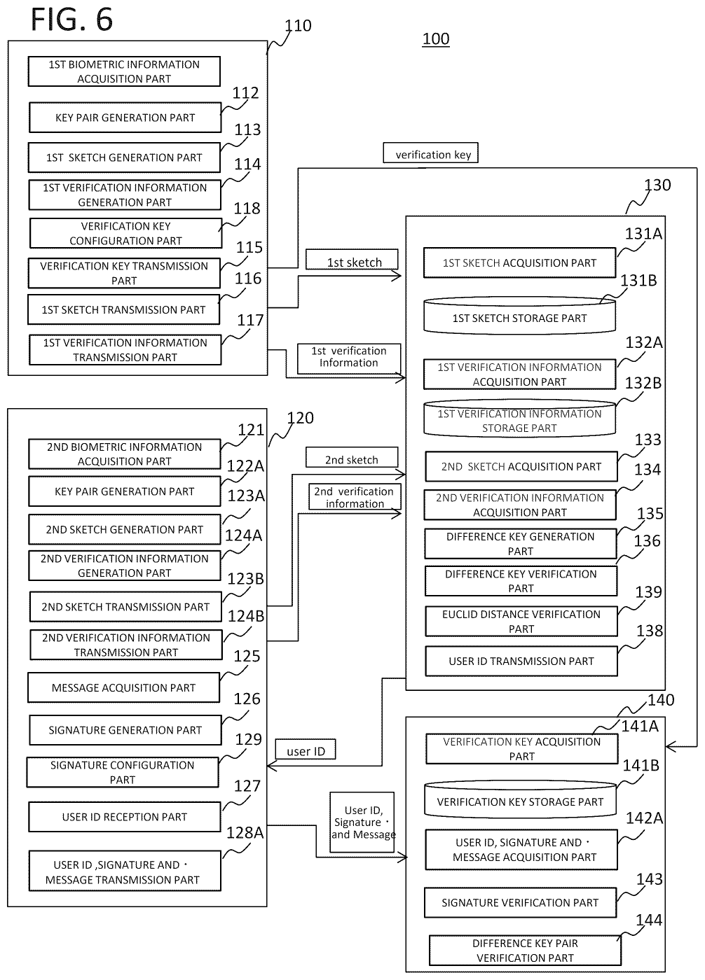

FIG. 6 is a diagram illustrating another example of an embodiment of the present disclosure, corresponding to the apparatus configuration in FIG. 3. As a difference from FIG. 3, in FIG. 6, the biometric key generation apparatus 110 further includes a verification key configuration part 118 that configures a verification key VK=(vk, s) using the verification key vk and the first sketch s.

The biometric-based signature generation apparatus 120 includes a key pair generation part 122A that generates a key pair consisting of a second signing key x′ and a second verification key vk′, instead of the key generation part 122 that generates the second signing key x′ in FIG. 3. The biometric-based signature generation apparatus 120 further includes a signature configuration part 129 that configures a signature (biometric signature) σ=(σ′,v′,s′) from the signature σ′ generated by the signature generation part 126, the second verification key v′ generated by the key pair generation part 122A, and the second sketch s′ generated by the second sketch generation part 123A.

In the user ID identification apparatus 130, the signature generation part 137 shown in FIG. 3 is removed and a Euclidean distance verification part 139 is provided.

The verification apparatus 140 includes a difference key pair verification part 144 in addition to the configuration shown in FIG. 3.

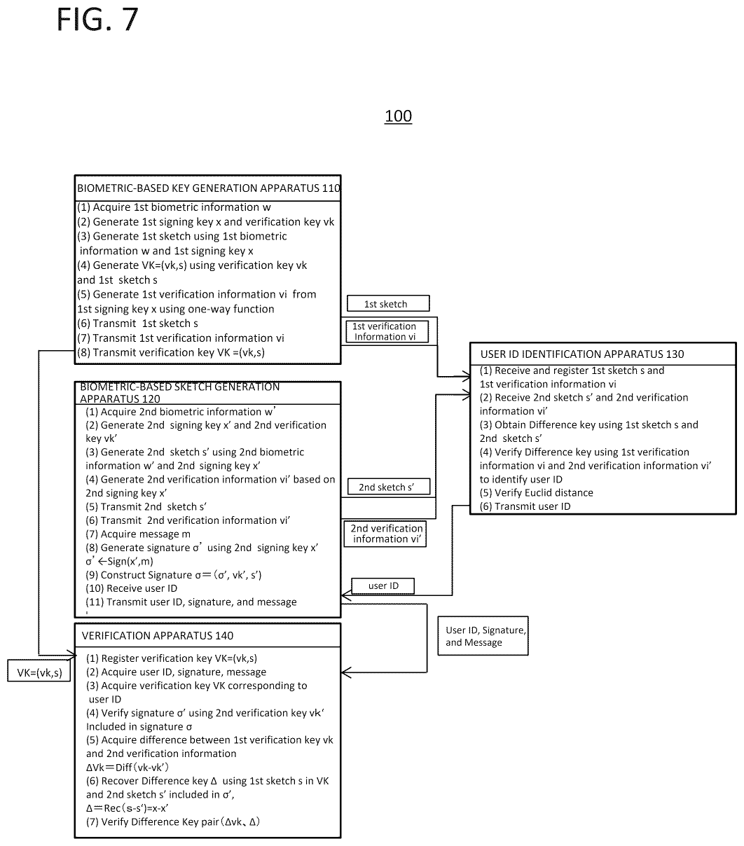

FIG. 7 is a diagram illustrating a process flow example of the signature system 100 shown in FIG. 6.

The biometric key generation apparatus 110 may perform the following processes.
(Step 1) The first biometric information acquisition part 111 acquires first biometric information w of a user.
(Step 2) The key pair generation part 112 generates a first signing key x and a verification key vk.
(Step 3) The first sketch generation part 113 generates a first sketch s using the first biometric information w and the first signing key x.

$$s := Enc ( x ) + w \qquad ( 75 )$$

(Step 4) The verification key construction part 118 generates a verification key VK=(s, vk) using the verification key vk and the first sketch s.
(Step 5) The first verification information generation part 114 generates first verification information vi by applying a homomorphic one-way function h to the first signing key x.

$$vi := h ( x ) \qquad ( 76 )$$

(Step 6) The first sketch transmission part 116 transmits the first sketch s to the user ID identification apparatus 130.
(Step 7) The first verification information transmission part 117 transmits the first verification information vi to the user ID identification apparatus 130.
(Step 8) The verification key transmission part 115 transmits the verification key VK=(vk, s) to the verification apparatus 140.

The first sketch s and the first verification information vi may be transmitted simultaneously. The first sketch s and the first verification information vi may be transmitted together with the user ID. The verification key VK may be transmitted together with the user ID. It is noted that Steps 1 and 2 may be performed in any order, Steps 3, 4, and 5 need not necessarily be performed in this order, and Steps 6, 7, and 8 need not necessarily be performed in this order.

The biometric-based signature generation apparatus 120 may perform the following processes.
(Step 1) The second biometric information acquisition part 121 acquires the second biometric information w′.
(Step 2) The key pair generation part 122A generates a set of the second signing key x′ and the second verification key vk′.
(Step 3) The second sketch generation part 123A generates the second sketch s′ (=ENC (x′)+w′) using the second biometric information w′ and the second signing key x′.
(Step 4) The second verification information generation part 124A generates the second verification information vi′ (=h (x′)) by applying a homomorphic one-way function h to the second signing key x′.
(Step 5) The second sketch transmission part 123B transmits the second sketch s′ to the user ID identification apparatus 130.
(Step 6) The second verification information transmission part 124B transmits the second verification information vi′ to the user ID identification apparatus 130.
(Step 7) The message acquisition part 127 acquires a message m to be signed.
(Step 8) The signature generation part 126 generates a signature σ′ for the message m using the second signing key x′.

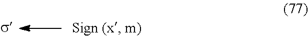

(Step 9) The signature configuration part 129 generates a signature σ=(σ′, vk′, s′) including the signature σ′, the second verification key vk′, and the second sketch s′.
(Step 10) The user ID reception part 127 receives the user ID transmitted from the user ID identification apparatus 130.
(Step 11) The user ID, signature, and message transmission part 128 transmits the user ID, the signature σ=(σ′, vk′, s′), and the message m to the verification apparatus 140.

It is noted that Steps 1 and 2 may be performed in any order, Steps 3 and 4 may be performed in any order, Steps 5 and 6 need not necessarily be performed in this order, and Step 7 may be performed in any order as long as it is before Step 9. Step 10 may be performed before Step 8.

The user ID identification apparatus 130 may perform the following processes.
(Step 1) The first sketch acquisition part 131A and the first verification information acquisition part 132A receive the first sketch s and the first verification information vi transmitted from the biometric key generation apparatus 110, and register them respectively in the first sketch storage part 131B and the first verification information storage part 132B corresponding to the user ID. For example, the first sketch storage part 131B and the first verification information storage part 132B may be configured as columns respectively storing fields of the first sketch and the first verification information of a record including the user ID, the first sketch s, and the first verification information vi. in a database (table).
(Step 2) The second sketch acquisition part 133 and the second verification information acquisition part 134 receive the second sketch s′ and the second verification information vi′, respectively.
(Step 3) The difference key generation part 135 obtains a difference key Δ using the first sketch s[k] registered in the first sketch s[k] registered as a kth set (kth row) in the storage part 131B and the second sketch s′.

$$Δ [ k ] = Rec ( s [ k ] , {s}^{′} ) ( = Dec ( s [ k ] - {s}^{′} ) ) \qquad ( 78 )$$

(Step 4) The difference key verification part 136 determines whether the first verification information vi[k] registered in the first verification information storage part 132B as the kth set (kth row), the second verification information vi′ and Δ[k] satisfy the following relation.

$$vi = h ( Δ [ k ] ) * {vi}^{′} \qquad ( 79 )$$

If the above holds, a user ID is set to k. Alternatively, the user ID may be set to ID[k], which is the user ID stored in the kth row in the first sketch storage part 131B.
(Step 5) As for the difference key Δ[k] (=x[k]−x′) between the first sketch s[k] (=Enc (x [k])+w[k]) in the kth row (kth row) stored in the first sketch storage part 131B, which corresponds to the user ID=k, corresponding to the kth user ID, and the second sketch s′ (=Enc (x′)+w′), a difference between the first biometric information w[k] and the second biometric information w′ is given as below,

$$w [ k ] - {w}^{′} = s [ k ] - Enc ( x [ k ] ) - ( {s}^{′} - Enc ( {x}^{′} ) ) = s [ k ] - {s}^{′} - Enc ( Δ [ k ] ) \qquad ( 80 )$$

Therefore, the Euclidean distance d(w[k], w′) between the first biometric information w[k]=(w₁, . . . , wₙ) and the second biometric information w′=(w′₁, . . . , w′ₙ) of an n-dimensional vector is computed as follows.

$$d ( w [ k ] , {w}^{′} ) = ‖ w [ k ] - {w}^{′} ‖ = √ \{ {( {w}_{1} - {w}_{1}^{′} )}^{2} + … + {( {w}_{n} - {w}_{n}^{′} )}^{2} \} = ‖ s [ k ] - {s}^{′} - Enc ( Δ [ k ] ) ‖ \qquad ( 81 )$$

The Euclidean distance verification part 139 may determine that the first biometric information w and the second biometric information w′ are not biometric information of an identical person when the Euclidean distance d (w, w′) exceeds a predetermined threshold th (d(w, w′)>th) and may interrupt a process (or return an error message).

In Equation (80), the encoding function Enc may be a function that generates an n-dimensional (integer) vector from an integer value (signing key). For example, the lattice point set L is defined as follows (e.g., Reference Literature 5).

$$L = \{ Y = ( {y}_{1} , … , {y}_{n} ) \vert {y}_{i} is a non - negative integer , 0 \leq {y}_{i} \leq K \} \qquad ( 82 )$$

where K is a predetermined integer that is sufficiently larger than th and an absolute value of |wᵢ|.

The function int( ) that maps an N-dimensional integer vector Y∈L to a single integer z may also be used an encoding function Enc.

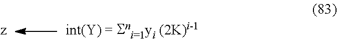

As a decoding function Dec which maps an integer z to an n-dimensional integer vector Y, an inverse function of the function int( ), int⁻¹( ) may be used.

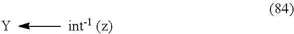

(6) The user ID transmission part 138 transmits the user ID to the biometric signature generation apparatus 120.

The verification apparatus 140 may perform the following processes:
(Step 1) The verification key acquisition part 141A receives the verification key VK=(vk, s) and registers it in the verification key storage part 141B. In this case, the row number at which the verification key VK=(vk, s) is registered in a table of the verification key storage part 141B may correspond to a row number of the first sketch storage part 131B and the first verification information storage part 132B of the user ID identification apparatus 130 where the first sketch and the first verification information are registered.
(Step 2) The user ID, signature, and message acquisition part 142 receives the user ID, signature σ, and message m transmitted from the biometric-based signature generation apparatus 120.
(Step 3) The signature verification part 143 obtains the verification key VK corresponding to the user ID from the verification key storage part 141B.
(Step 4) The signature verification part 143 verifies the signature σ′ for the message m using the second verification key vk′ included in signature σ=(σ′, vk′, s′).

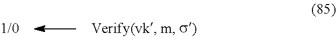

If the verification of the signature fails (rejected), the signature verification part 143 may interrupt a process (or returns an error message to a sender of the signature).
(Step 5) If the verification of the signature succeeds (accepted), the difference key pair verification part 144 computes a difference Δvk between the verification key vk included in the verification key VK=(vk, s) and the second verification key vk′, using the function Diff.

$$Δ vk = Diff ( vk , {vk}^{′} ) \qquad ( 86 )$$

(Step 6) The signature verification part 143 restores a difference key Δ using the first sketch s included in the verification key VK=(vk, s) and the second sketch s′ included in the biometric signature σ=(σ′, vk′, s′) using the restoration function Rec.

$$Δ = Rec ( s , {s}^{′} ) \qquad ( 87 )$$

As the recovery function Rec (s, s′) is composed of a decoding function Dec(s-s′) such that

$$\begin{matrix}Δ = Rec ( s , {s}^{′} ) = Dec ( s - {s}^{′} ) \\ = Dec ( Enc ( x ) + w - ( Enc ( {x}^{′} ) + {w}^{′} ) ) \\ = Dec ( Enc ( x - {x}^{′} ) + w - {w}^{′} )\end{matrix} \qquad ( 88 )$$

When a difference (distance) between the first biometric information w and the second biometric information w′ is within a correction range,

$$Δ = x - {x}^{′} \qquad ( 89 )$$

(Step 7) The difference key pair verification part 144 verifies whether Δvk=vk−vk′ and Δ are in a predetermined relationship. In the case of the above-mentioned Schnorr signature scheme,

$$Δ vk = Diff ( vk , {vk}^{′} ) = gx / {gx}^{′} mod p \qquad ( 90 )$$

then,

$$Δ vk = g Δ mod p \qquad ( 91 )$$

If the verification of the difference between the verification key and the signing key by the difference key pair verification part 144 is successful, the verification of the signature is deemed finally to be a final success.

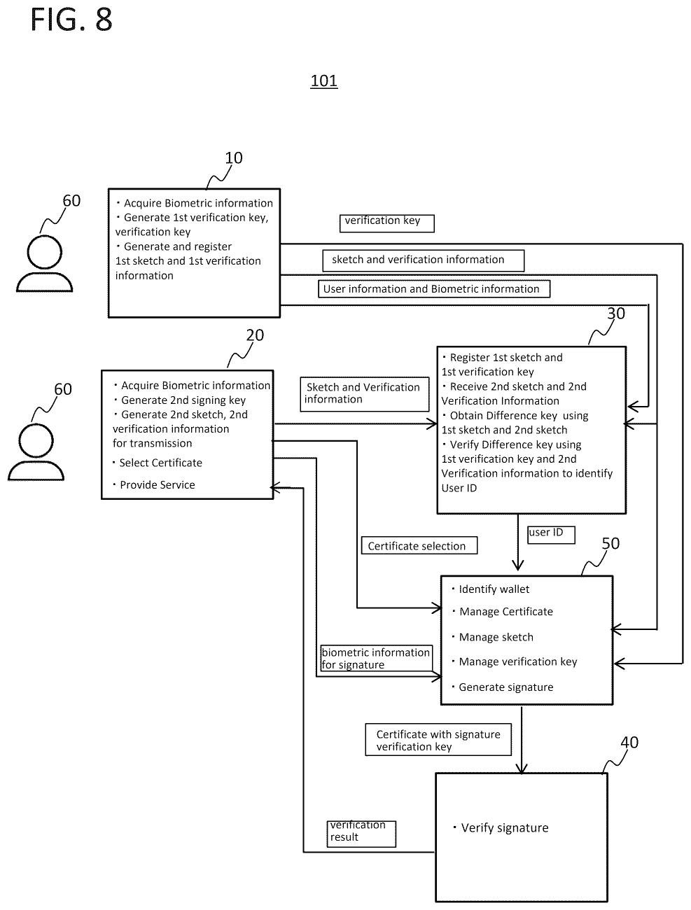

As an example of a use case of the above-described embodiments, the following describes an example of application to a wallet system. A custodial wallet (managed wallet) entrusts holding and management of a private key required for accessing and managing assets (digital assets) and/or asset transactions to a service provider. The custodial wallet offers convenience, such as ease of use and simple setup. However, in the custodial wallet, there are some issues in terms of data privacy and security, such as a risk of fraud by a malicious service provider and a risk of data compromise or leakage in a service provider. In a non-custodial wallet, users are responsible for holding and managing their own private keys. Therefore, proper management of a private key becomes responsibility of an individual user. Non-custodial wallets often require apparatuses such as smartphones for storing and managing private keys, thus making hands-free use difficult. FIG. 8 is a schematic diagram illustrating a non-limiting example of a wallet system (electronic wallet system) 101 in which the signature system 100 of the above described embodiments of the present disclosure is applied to a hands-free non-custodial wallet system.

In FIG. 8, the terminal 10 is a terminal where the user 60 registers a sketch, verification information, and user information in advance on the user ID identification apparatus 30, etc. Depending on a system configuration, modalities of biometric information for identifying a user ID and biometric information used to generate signature for a certificate selected by the user may be the same or different. For example, facial information may be used as biometric information for identifying a user ID, and finger vein information may be used for generating a signature for the certificate. In this case, the terminal 10 may acquire facial information as first biometric information w, generate a first sketch s (=Enc (w)+x) using the first signing key x and the first biometric information w, generate first verification information vi from the first signing key x, and register them in the user ID identification apparatus 30. The terminal 10 may also generate a sketch using finger vein information as biometric information and register it in the certificate management apparatus 50. In the example of FIG. 8, the terminal 10 transmits the first sketch s and the first verification information vi along with the user ID to the user ID identification apparatus 30, and the user ID identification apparatus 30 stores and manages the first sketch s and the first verification information vi corresponding to the user ID. The user ID identification apparatus 30 may be configured to include the user ID identification apparatus 130 of FIG. 2.

The terminal 10 may transmit n pairs of first sketches and the first verification key (s1, vk1) to (sn, vkn) (n is an integer greater than or equal to 1), where the first sketch s was generated using the first signing key x and the first biometric information w to the certificate management apparatus 50 for registration in advance.

When the user 60 (the same user 60 who performed in advance the registration operation on terminal 10) receives a service (such as boarding pass, accommodation voucher, ticket purchase, payment, coupon issuance, or point award) at a terminal 20 arranged in a facility, the terminal 20 acquires the second biometric information w′ of the user 60, such as facial information (or iris, finger/palm vein), using a camera or sensor not shown. The terminal 20 may generate a second sketch s′ using the second signing key x′ and the second biometric information w′, generate a second verification information vi′ from the second signing key x′, and transmit the second sketch s′ and the second verification information vi′ to the user ID identification apparatus 30.

The user ID identification apparatus 30 may receive the second sketch s′ and the second verification information vi′ transmitted from the terminal 20, and compute a difference key Δ[k] (=Rec (s [k], s′) for the kth set of the first sketch s[k] and the second sketch s′ and compares the kth set of first verification information vi[k] and second verification information vi′ to check whether they satisfy the following relation.

$$vi [ k ] = h ( Δ [ k ] ) * {vi}^{′} \qquad ( 92 )$$

If the above relation holds, the user ID identification apparatus 30 may identify the ID[k] of the kth set as the user ID of the user of the second biometric information w′.

The user ID identification apparatus 30 uses the first sketch s[k] (=Enc(x[k])+w[k]) (k={1, . . . , N}), the second sketch s′, and the difference key Δ[k] to compute the Euclidean distance d (w [k], w′) (L2 norm) between the first biometric information w[k] and the second biometric information w′ as a distance between the first sketch w[k] and the second sketch w′ according to the above Equation (80) and (81), and determine whether the Euclidean distance d(w[k], w′) (L2 norm) is below a predetermined threshold to confirm identity or authenticity that the first biometric information w[k] and the second biometric information w′ used to generate the first sketch s[k] are from the identical user.

In the configuration where the terminal 20 includes the biometric-based signature generation apparatus 120 described with reference to, for example, in FIG. 2, the message m may be a predetermined certificate of a wallet identified by a user ID. In this case, the terminal 20 may generate a signature σ for the message m and transmit the signature σ and the message m together with the user ID to the verification apparatus 140 described with reference to, for example, in FIG. 2. Alternatively, as a not limiting example, the message m may be a challenge (e.g., a random number) transmitted from the user ID identification apparatus 30 to the terminal 20. In this case, the terminal 20 may generate a biometric-based signature for the challenge, transmit the signature along with the user ID to the verification apparatus 40, which may verify the signature and notify the user ID identification apparatus 30 if the verification result is successful (accepted). Alternatively, in a configuration where the first verification information vi stored with the first sketch s in the user ID identification apparatus 30 is set as the verification key vk corresponding to the first signing key x, the terminal 20 may generate a biometric-based signature in response to the challenge and transmit the signature to the user ID identification apparatus 30, which may verify the signature using the kth verification key vk [k] registered in advance in the storage part (DB). In this case, if the signature verification is successful (accepted), the user ID identification apparatus 30 may transmit the user ID to the certificate management apparatus 50. It is noted that when registering in advance the first sketch and first verification information from the terminal 10 to the user ID identification apparatus 30, the user ID may be transmitted from the terminal 10 to the user ID identification apparatus 30 together with the first sketch s and the first verification information vi, or an account ID used when the user 60 logs in to the user ID identification apparatus 30 from the terminal 10 may be used as the user ID.

The certificate management apparatus 50 may receive the user ID transmitted from the user ID identification apparatus 30 to identify a wallet of the user 60 from the user ID. The certificate management apparatus 50 may store the wallet of the user 60 (which is an electronic wallet, also known as a virtual wallet) in a storage part in correspondence with the user ID. Although not limited thereto, in this case, the user ID is common to both the certificate management apparatus 50 and the user ID identification apparatus 30. If the user ID differs between the certificate management apparatus 50 and the user ID identification apparatus 30, the user ID from the user ID identification apparatus 30 may be converted to the user ID in the certificate management apparatus 50 using a conversion table or the like before identifying the wallet of the user 60.

The wallet (virtual wallet) of the user 60 stored and managed by the certificate management apparatus 50 may be configured to retain one or more certificates of the user 60. The wallet may, as a matter of course, be empty. In the wallet of the user 60, the certificate may be stored in correspondence with a service ID(s) thereof. The wallet of the user 60 may be configured as a folder (directory) under each folder (directory) of each user in the storage, and the certificate(s) in the wallet may be configured as an electronic file(s) in the wallet folder (directory). That is, the data structure in the storage of the certificate management apparatus 50 may be configured such that one or more certificate entries are arranged under the wallet entry corresponding to the user ID.

The certificate management apparatus 50 may select a certificate m (SID) from among one or more certificates stored in the wallet of the user 60 that corresponds to the ID (SID) of a service that the user 60 is going to receive. This selection may be performed, for example, by the certificate management apparatus 50 that may display one or more certificates (corresponding to one or more services) stored in the wallet of the user 60 on a screen of the terminal 20, and the terminal 20 that may transmit the service ID selected by the user 60 on the screen of the terminal 20 to the certificate management apparatus 50.

The certificate management apparatus 50 may store one or more sketches (first sketches) ss corresponding to one or more service IDs (SIDs) provided to the user in a storage part not shown. The certificate management apparatus 50 may also store one or more verification keys vks corresponding to one or more service IDs (SIDs) provided to the user in an unillustrated storage part. That is, the certificate management apparatus 50 may be configured to store, for each user ID, s (SID) as a sketch (first sketch) and vk (SID) as a verification key (SID=[1, . . . , n] where n is an integer greater than or equal to 1).

The certificate management apparatus 50 may obtain the first sketch s (SID) corresponding to the service ID (SID) corresponding to a service to be received by the user, obtain the second biometric information w′ from the terminal 20, and generate a signature σ for the certificate m (SID) using the first sketch s (SID) and the second biometric information w′.

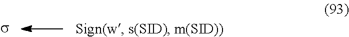

The function Sign takes w′, s (SID), and m (SID) as input arguments and performs the following computation as inside routine of the function:

$$Dec ( s - {w}^{′} ) = Dec ( Enc ( x ) + w - {w}^{′} ) \qquad ( 94 )$$

If a difference between the first biometric information w and the second biometric information w′ is within a correction range, Dec(s−w′)=x holds where a return value of the Sign function is σ, and a value of Dec(s−w′) is not outputted outside the Sign function, thus preventing x from being revealed or compromised, and a signature σ equivalent to the signature for the certificate m (SID) generated using the first signing key x is generated.

Alternatively, the certificate management apparatus 50 may restore the difference key Δ from a difference between the first sketch s and the second sketch s′, and use the difference key Δ to generate the first distributed signature for the certificate m(SID). The terminal 20 may generate a second distributed signature for the certificate m (SID) using the second signing key x′ and combine the first distributed signature and the second distributed signature to generate a signature for the certificate m (SID). Alternatively, a list of a plural sets of certificates ms and service IDs registered in advance in the wallet may be displayed on the terminal 20, and the certificate m (SID) corresponding to the service ID (SID) selected by the user 60 on the terminal 20 may be selected.

The certificate management apparatus 50 may transmit the certificate m(SID) with the signature σ added (signed certificate) and the verification key vk (SID) which is a public key for verifying the signature σ, to the verification apparatus 40. Alternatively, the signature σ, the certificate m (SID), and the verification key vk (SID) may be transmitted separately.

The verification apparatus 40, using the verification key vk (SID), verifies whether a set of the certificate m (SID) and the signature σ is correct. The verification apparatus 40 transmits a verification result of the signature to the terminal 20.

When the verification result of the signature is a success, the service corresponding to the verified certificate is provided to the user 60 at the terminal 20. The terminal 20 provides a service corresponding to the verified certificate of the user's wallet, such as providing a ticket, points, coupons, etc.

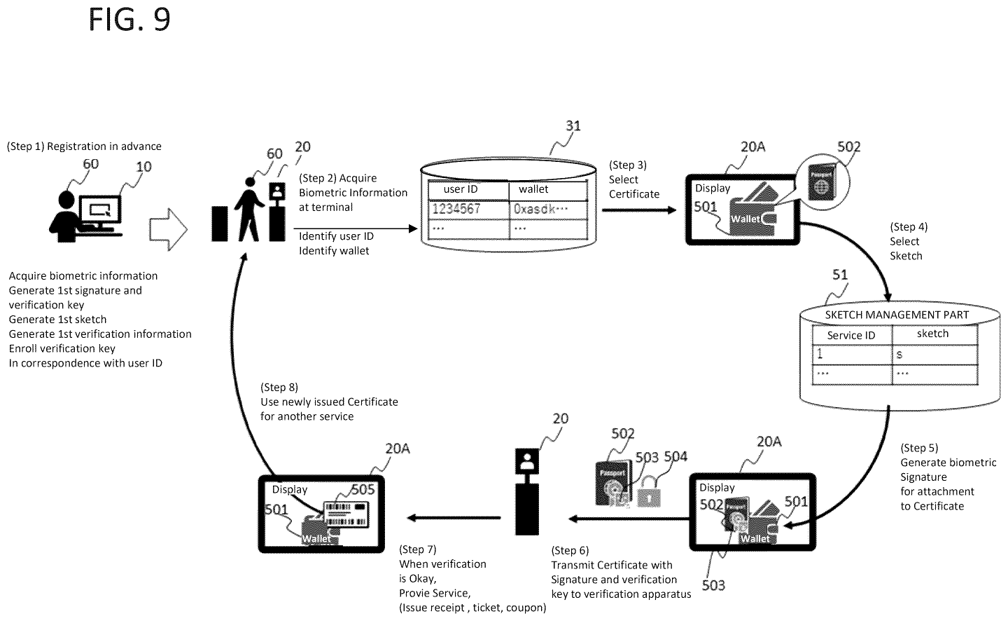

FIG. 9 schematically illustrates an example of a screen (terminal screen) 20A displayed on terminal 20. The user ID identification apparatus 30 sets the kth ID[k] as the user ID when the relationship vi[k]=h(Δ[k])*vi′ is satisfied for the second sketch s′ and the second verification information vi′ with respect to the kth first sketch s[k] and first verification information vi[k] that are registered in advance. The certificate management apparatus 50 automatically selects the certificate corresponding to a service ID associated with the user ID. In this case, the user does not need to select the certificate on the terminal 20. For example, if a user ID of the user is obtained through vein authentication, a certificate corresponding to the user ID may be automatically selected, and a signature may be generated using the vein information that was used for biometric authentication. The verification apparatus may verify the signature using the verification key, and if the verification result is successful (accepted), the service (e.g., payment service) may be provided on the terminal 20.
(Step 1) The terminal 10 may acquire biometric information (e.g., facial features) for biometric authentication, generate a pair of a signing key and a verification key, and register in advance the first sketch generated using the biometric information and the signing key, and the first verification information in the user ID identification apparatus 30. User information may also be registered in the user ID identification apparatus 30.

The terminal 10 may acquire biometric information (e.g., finger veins) for signature generation, generate multiple sets of signing keys and verification keys, and transmit n sets of sketches that are respectively generated using the same biometric information and n signing keys for signature generation) and verification keys corresponding to the signing keys in correspondence with services (service IDs) that the user 60 is able to receive on terminal 20 (s1, vk1), . . . , (sn,vkn) (where n is an integer not less than 1) in advance to the certificate management apparatus 50 for registration. During the registration process on the terminal 10, the user 60 has set up correspondence between the user's wallet, service, and a helper key (sketch) on terminal 10. The user 60 is allowed to use a service(s) (such as purchasing a ticket(s) or adding a purchased ticket(s) to the wallet) on the terminal 20 (the terminal in a facility) without performing any actions other than just presenting his or her biometric information.
(Step 2) The user 60 may obtain a user ID from the user ID identification apparatus 30 by holding his or her face to a camera of the terminal 20.
(Step 3) The certificate management apparatus 50 may search a storage apparatus (service database 31) within the certificate management apparatus 50 using the user ID output from the user ID identification apparatus 30, and select the certificate 502 stored in the wallet 501 corresponding to the user ID (the certificate corresponding to the user ID is automatically selected from the user ID). In FIG. 9, the certificate 502 retrieved (selected) from the wallet 501 in the certificate management apparatus 50 is schematically illustrated on the terminal screen 20A.
(Step 4) A sketch management part 51 of the certificate management apparatus 50 may select a sketch corresponding to the service (service ID: SID) for the certificate 502 that is selected in Step 3.
(Step 5) The certificate management apparatus 50 may generate a signature 503 for the certificate using the second biometric information w′ (e.g., vein information) obtained from the terminal 20 for generating the user's signature (distributed signature) and the sketch selected in step 4, and attaches the signature 503 to the certificate 502.
(Step 6) The certificate management apparatus 50 obtains a verification key 504 (vk [SID]) corresponding to the service ID from among the verification keys of the user 60, and transmits the certificate 502, the signature 503, and the verification key 504 to the terminal 20.
(Step 7) The terminal 20 may verify the signature 503 attached on the certificate 502 using the verification key 504. If the verification result is a success (accepted), the terminal 20 may provide the user 60 with the service corresponding to the service ID (e.g., an airline ticket purchasing procedure, a ticket purchasing procedures, or hotel reservation procedure). If the verification result is a failure (rejected), the service is not provided. FIG. 9 illustrates a purchased ticket 505 being added to the wallet 501 on the terminal screen 20A.
(Step 8) As a result of the service provision on the terminal 20, ticket registration, issuance of points or coupon may be performed in the wallet 501 of the user 60 in the certificate management apparatus 50. The user 60 can use the ticket(s), etc. issued as a result of the service provision on the terminal 20 as a new certificate(s) to access other service(s) provided by verifying the ticket(s). Additionally, information such as electronic money card information, tickets, and coupons in the user's wallet in the certificate management apparatus 50 may be transferred to the user's smartphone wallet application. Alternatively, a certificate stored in a wallet application on a smartphone of a user may be made transferable to the user's wallet in the certificate management apparatus 50.

The user ID identification apparatus 30 in FIG. 8 (including the user ID identification apparatus 130 in FIG. 1) may, as a matter of course, be applied to an authentication service (authentication system) other than the electronic wallet system. As described above, when implementing the user ID identification apparatus 30 as an authentication apparatus (authentication server), the user ID identification apparatus 30 is configured to receive the second verification information vi′ generated based on the second sketch s′ generated using the second biometric information w′ of a user to be authenticated acquired at the terminal 20 and the second signing key x′ generated at the terminal 20. As for N sets of the first sketch and the first verification information vi stored in a storage part (DB) not shown, wherein the difference key Δ[k] (=Rec(s[k], s′) computed using the first sketch s[k] of the kth set and the second sketch s′, the first verification information vi[k] and the second verification information vi′ satisfy the following relation:

$$vi [ k ] = h ( Δ [ k ] ) * {vi}^{′} , \qquad ( 94 )$$

the user ID identification apparatus 30 may determine that the user to be authenticated may match (or be a candidate for matching) a user of the first biometric information w[k] used to generate the first sketch s[k] of the kth set, which is registered in advance in the storage part (DB) not shown. When determining as a candidate, the user ID identification apparatus 30 may, using the first sketch s[k] of the kth set (k={1, . . . , N]), the second sketch s′ transmitted from the terminal 20, and the difference key Δ[k], compute, as a distance between the first biometric information w[k] and the second biometric information w′ according to Equations (80) and (81), a Euclidean distance d(w[k], w′) (L2 norm) between the first biometric information w[k](k={1, . . . , N}) and the second biometric information w′. The user ID identification apparatus 30 then determines whether the Euclidean distance d (w [k], w′) (L2 norm) is less than or equal to a predetermined threshold th. If d(w[k], w′) is less than or equal to the threshold th, it may be determined that the user of the first biometric information w[k] used to generate the first sketch s[k] and the user of the second biometric information w′ are an identical user (identity authentication) (two-step determination). On the other hand, even if the difference key Δ[k], the first verification information vi[k] and the second verification information vi′ satisfy Equation (94), if the Euclidean distance d(w[k], w′) exceeds the threshold th, it is also possible to configure the system so that the user of the first biometric information w[k] and the second biometric information w′ are not recognized as an identical person. It is noted that depending on the biometric information, a Hamming distance or other distance may be used instead of the Euclidean distance.

In the authentication apparatus (authentication server) configured using the user ID identification apparatus 30, instead of registering biometric information in advance in a storage part (DB), a set of the first sketch s and the first verification information vi transmitted from the terminal 10 is registered. Therefore, compared to a well known biometric authentication apparatus that performs 1: N collation with registered biometric information, it is possible to ensure security while significantly reducing a load for avoiding compromise of biometric information. It is noted that when implementing the user ID identification apparatus 30 as a biometric authentication apparatus, it is as a matter of course possible to use the verification key vk corresponding to the first signing key x as the first verification information vi to be stored together with the first sketch s. In this case, as described above, the terminal 20 (e.g., the biometric-based signature generation apparatus 120 in FIG. 2) generates a signature (e.g., a biometric-based signature) for a challenge transmitted from the biometric authentication apparatus as a message m to be signed and transmits it to the user ID identification apparatus 30. The user ID identification apparatus 30 may then verify the signature using the kth verification key vk [k] registered in advance in the storage part (DB).

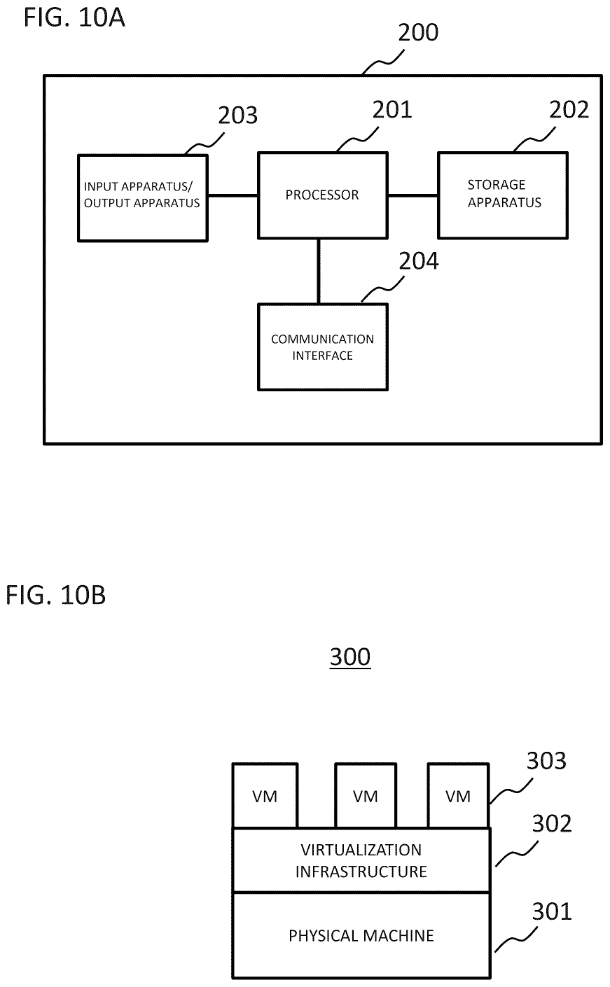

FIG. 10A and FIG. 10B are schematic diagrams each illustrating an example of implementing the above-described digital signature system 100 using computers equipped with communication functions and capable of communicating with each other via a network. Referring to FIG. 10A, each apparatus (110, 120, 130, 140) in FIG. 2 includes a processor 201 (multiple processors are also possible), a storage apparatus 202, an input/output apparatus 203, and a communication interface 204. The storage apparatus 202 may include a semiconductor storage(s) such as RAM (Random Access Memory), ROM (Read Only Memory), or EEPROM (Electrically Erasable and Programmable ROM), as well as HDD (Hard Disk Drive), CD (Compact Disc), or DVD (Digital Versatile Disc). The processor 201 executes a program (not shown) stored in the storage apparatus 202 to implement the processing and functions of each apparatus. The input/output apparatus 203 may also be configured with a keyboard and display. In the biometric-based key generation apparatus 110 and the biometric-based signature generation apparatus 120 that acquire biometric information, the input/output apparatus 203 may also be configured to include a sensor for acquiring biometric information. In this case, the sensor may be an image sensor (camera) when the biometric information is a face, iris, etc., a fingerprint sensor when the biometric information is a fingerprint, or, for example, an LED (Light Emitting Diode) that emits near-infrared light and a near-infrared camera that captures the light transmitted through the finger when the biometric information is a finger/palm vein. It is noted that the sensor may also be a removable sensor, such as a USB (Universal Serial Bus) apparatus. The communication interface 204 may be configured to communicate with each other via a LAN (Local Area Network), WAN (Wide Area Network) such as the Internet, wireless LAN, mobile communication network, etc., using a network interface card, transceiver, etc. The communication interface 204 may be configured to communicate with external sensors (e.g., Bluetooth-connected sensors) in the biometric-based key generation apparatus 110 and the biometric-based signature generation apparatus 120, and to receive biometric information acquired by the external sensors.

FIG. 10B is a schematic diagram illustrating an example in which one or more of the apparatuses (110, 120, 130, 140) of the signature system 100 described above are implemented as virtual machines of a virtualization system 300 using server virtualization technology. Multiple virtual machines (Virtual Machine: VM) 303 operate on a virtualization infrastructure 302, such as a hypervisor, implemented on a physical machine 301, such as a server apparatus. One or more of the apparatuses (110, 120, 130, 140) of the signature system 100 may be implemented as virtual machines (VM) 303. With a single physical server, a virtualized server environment where multiple servers are running is provided. Each virtual machine (VM) 303 is preferably configured to operate in an isolated environment within memory space. In this case, within the virtual machine VM, a program that implements the processing of any of the apparatuses (110, 120, 130, 140) runs on the virtual machine's virtual operating system (OS). The virtual machine VM, which virtually implements any of the apparatuses (110, 120, 130, 140) may be configured to communicate with other virtual machines via a virtual network, or may be configured to communicate with other apparatuses (110, 120, 130, 140) via a LAN, Internet, or other WAN through the physical interface (communication interface) of the physical machine 301. In this case, a plurality of virtual machines VM 303 do not need to be executed on the same physical machine, and may be configured to be connected for communication with one or more virtual machines VMs executed on other physical machines.

The above embodiment is supplemented as follows, though not limited thereto.

(Note 1) A system includes at least first to third apparatuses, each of which includes at least a processor and a communication interface.

The first apparatus is configured to:
generate a first sketch using first biometric information of a user and a first signing key;
generate first verification information based on the first signing key; and
transmit the first sketch and the first verification information to the third apparatus.

The second apparatus is configured to:
generate a second sketch using second biometric information of the user and second signing key;
generate second verification information based on the second signing key; and
transmit the second sketch and the second verification information to the third apparatus.

The third apparatus includes a storage part that stores N (where Nis an integer not less than 1) set(s) of the first sketch and the first verification information transmitted from one or more instances of the first apparatus, the processor included in the third apparatus configured to:
receive the second sketch and the second verification information transmitted from the second apparatus;
for the N set(s) of the first sketch and the first verification information stored in the storage part,
restore a difference key by using the first sketch of a kth set (where k is an integer not less than 1 and not more than N) and the second sketch; and
identify an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

(Note 2) In the signature system of Note 1, the first apparatus is configured to
generate the first verification information by applying a homomorphic one-way function to the first signing key, and
the second apparatus is configured to
generate the second verification information by applying the homomorphic one-way function to the second signing key.

(Note 3) In the signature system described in Note 2,
the third apparatus is configured to
determine whether an additive homomorphic relation holds among
between an operation result of a value obtained by applying a homomorphic one-way function to the difference key restored using the first sketch and the second sketch and the second verification information that is a value obtained by applying the homomorphic one-way function to the second signing key, and
the first verification information that is a value obtained by applying the homomorphic one-way function to the first signing key, for a plurality of sets of the first sketch and the first verification information stored in the storage part.

(Note 4) In any of the signature system of any one of Notes 1 to 3, the third apparatus is configured to transmit the identified user ID to the second apparatus, and
the second apparatus is configured to generate a signature for a message to be signed using the second biometric information.

(Note 5) In any of the signature system of any one of Notes 1 to 4, a fourth apparatus is provided that stores and retains a verification key for each user to perform signature verification.

The second apparatus transmits the user ID, the signature, and the message to the fourth apparatus, which verifies the signature for the message using the verification key corresponding to the user ID.

(Note 6) In any of the signature system of any one of Notes 1 to 5, the second apparatus and the third apparatus are configured to:
communicate with each other in accordance with a signature generation protocol, and
generate first and second distributed signature using the second signing key and the difference key;
one of the second apparatus or the third apparatus
is configured to combine the first and second distributed signatures to generate a signature equivalent to a signature generated for the message using the first signing key.

(Note 7) In any of the signature system of any one of Notes 1 to 5, the second apparatus is configured to
generate the second signing key and a second verification key;
generate a signature for the message using the second signing key; and
transmit the signature, the second verification key, and the second sketch to a fourth apparatus.

The first apparatus is configured to
transmit the verification key and the first sketch to the third apparatus.

The fourth apparatus is configured to
using the second verification key, verify the signature, and
generate a difference key using the first sketch and the second sketch, and
verify whether the verification key corresponding to the user ID, the second verification key, and the difference key satisfy a predetermined relation.

(Note 8) In any of the signature system of any one of Notes 1 to 7, the third apparatus is configured to
compute a distance between the first biometric information and the second biometric information using a difference between the first sketch and the second sketch and the difference key to verify whether the distance is within a predetermined threshold.

(Note 9) In any of the signature system of any one of Notes 1 to 7, the third apparatus includes the storage part that stores a set of the first sketch and the first verification information in a single record,
a row number of the record including the kth set of the first sketch and the first verification information in the storage part that satisfy the predetermined condition being set as the user ID, or a value of the user ID field of the record is set as the user ID.

(Note 10) A signature method comprising:
by a first apparatus:
generating a first sketch using first biometric information of a user and a first signing key;
generating first verification information based on the first signing key; and
transmitting the first sketch and the first verification information to a third apparatus, the method comprising:
by the second apparatus:
generating a second sketch using second biometric information of the user and second signing key;
generating second verification information based on the second signing key; and
transmitting the second sketch and the second verification information to the third apparatus, the method comprising:
by the third apparatus a storage part that stores N (where Nis an integer not less than 1) set(s) of the first sketch and the first verification information received from one or more of the first apparatuses:
on reception of the second sketch and the second verification information, for a plurality of sets of the first sketch and the first verification information stored in the storage part;
restoring a difference key using the first sketch stored in the storage part and the second sketch received; and
identifying, an ID (identification information) corresponding to a set of the first sketch and the first verification information with a predetermined condition regarding the first verification information, the second verification information, and the difference key being satisfied, as a user ID.

(Note 11) In the signature method of Note 10, comprising:
generating, by the first apparatus, the first verification information by applying a homomorphic one-way function to the first signing key; and
generating, by the second apparatus, the second verification information by applying the homomorphic one-way function to the second signing key.

(Note 12) In the signature method of Note 11, comprising
determining, by the third apparatus, whether an additive homomorphic relation holds between an operation result of a value obtained by applying a homomorphic one-way function to the difference key restored using the first sketch and the second sketch and the second verification information that is a value obtained by applying the homomorphic one-way function to the second signing key, and
the first verification information that is a value obtained by applying the homomorphic one-way function to the first signing key, for a plurality of sets of the first sketch and the first verification information stored in the storage part.

(Note 13) In any of the signature method of any one of Notes 10 to 12, comprising:
transmitting, by the third apparatus, the identified user ID to the second apparatus; and
generating by a second apparatus, a signature for the message to be signed using the second biometric information.

(Note 14) In any of the signature method of any one of Notes 10 to 12, comprising:
transmitting, by the second apparatus, the user ID, the signature, and the message to a fourth apparatus that stores and retains a verification key for each user to perform signature verification; and
verifying, by the fourth apparatus, the signature for the message using the verification key corresponding to the user ID.

(Note 15) In the signature method of Note 13, comprising
communicating, by the second apparatus and the third apparatus, with each other in accordance with a signature generation protocol,
generate, by the second apparatus and the third apparatus, first and second distributed signature using the second signing key and the difference key; and
combining, by one of the second apparatus or the third apparatus the first and second distributed signatures to generate a signature equivalent to a signature generated for the message using the first signing key.

(Note 16) In the signature method described in Note 13, comprising by the second apparatus:
generating the second signing key and the second verification key,
generating a signature for the message using the second signing key, and
transmitting the signature, the second verification key, and the second sketch to the fourth apparatus,
the method comprising
by the first apparatus, transmitting the verification key and the first sketch to the third apparatus, the method comprising:
by the fourth apparatus:
using the second verification key, verifying the signature;
generating a difference key using the first sketch and the second sketch; and
verifying whether the verification key corresponding to the user ID, the second verification key, and the difference key satisfy a predetermined relation.

(Note 17) In any of the signature method of any one of Notes 10 to 14, comprising:
computing, by the third apparatus, a distance between the first biometric information and the second biometric information using a difference between the first sketch and the second sketch and the difference key to verify whether the distance is within a predetermined threshold.

(Note 18) In any of the signature method of any one of Notes 10 to 12, comprising
by the third apparatus including the storage part that stores a set of the first sketch and the first verification information in a record,
setting a row number of the record including the kth set of the first sketch and the first verification information in the storage part that satisfy the predetermined condition as the user ID, or setting a value of the user ID field of the record as the user ID.

(Note 19) A non-transitory storage medium storing a program causing a first processing apparatus to perform processing comprising:
generating a first sketch using first biometric information of a user and a first signing key;
generating first verification information based on the first signing key; and
transmitting the first sketch and the first verification information to a third processing apparatus, wherein the non-transitory storage medium stores a program causing a second processing apparatus to perform processing comprising:
generating a second sketch using second biometric information of the user and second signing key;
generating second verification information based on the second signing key; and
transmitting the second sketch and the second verification information to the third apparatus, wherein the non-transitory storage medium stores a program causing the first processing apparatus to perform processing comprising:
storing in a storage part N (where Nis an integer not less than 1) set(s) of the first sketch and the first verification information received from one or more of the first processing apparatuses;
on reception of the second sketch and the second verification information, for a plurality of sets of the first sketch and the first verification information stored in the storage part;
restoring a difference key using the first sketch stored in the storage part and the second sketch received; and
identifying, an ID (identification information) corresponding to a set of the first sketch and the first verification information with a predetermined condition regarding the first verification information, the second verification information, and the difference key being satisfied, as a user ID.

(Note 20) A user ID identification apparatus including at least a processor and a communication interface, wherein the processor is configured to:
receive a first sketch generated using first biometric information and a first signing key, and first verification information generated based on the first signing key and store a set of the first sketch and the first verification information in a storage part;
receive a second sketch generated using second biometric information and d a second signing key, and second verification information generated based on the second signing key;
restore a difference key using the first sketch stored in the storage and the second sketch, for one or more sets of the first sketch and the first verification information; and
identify, an ID (identification information) corresponding to a set of the first sketch and the first verification information with a predetermined condition regarding the first verification information of the set, the second verification information, and the difference key being met, as a user ID.

(Note 21) A non-transitory storage medium storing a program causing a first processing apparatus to perform processing comprising:
receiving a first sketch generated using first biometric information and a first signing key, and first verification information generated based on the first signing key and storing a set of the first sketch and the first verification information in a storage part;
receiving a second sketch generated using second biometric information and a second signing key, and second verification information generated based on the second signing key;
restoring a difference key using the first sketch stored in the storage and the second sketch, for one or more sets of the first sketch and the first verification information; and
identifying, an ID (identification information) corresponding to a set of the first sketch and the first verification information with a predetermined condition regarding the first verification information of the set, the second verification information, and the difference key being met, as a user ID.

(Note 22) An authentication apparatus including at least a processor, a memory storing a program executable by the processor, and a communication interface, wherein the processor is configured to:
receive a first sketch generated using first biometric information of a user and a first signing key, and first verification information generated based on the first signing key from at least one first apparatus and store a set of the first sketch and the first verification information as registration information in a storage part;
receive a second sketch generated using second biometric information of a user to be authenticated and a second signing key, and second verification information generated based on the second signing key;
restore a difference key using the first sketch stored in the storage and the second sketch, for a plurality of sets of the first sketch and the first verification information;
check whether a predetermined condition holds among the first verification information, the second verification information, and the difference key; and
if the predetermined condition holds, authenticate the user to be authenticated identical to the user of the first biometric information used to generate the first sketch.

(Note 23) A non-transitory storage medium storing a program causing a first processing apparatus to perform processing comprising:
receiving a first sketch generated using first biometric information of a user and a first signing key, and first verification information generated based on the first signing key from at least one first apparatus and store a set of the first sketch and the first verification information as registration information in a storage part;
receiving a second sketch generated using second biometric information of a user to be authenticated and a second signing key, and second verification information generated based on the second signing key;
restoring a difference key using the first sketch stored in the storage and the second sketch, for a plurality of sets of the first sketch and the first verification information;
checking whether a predetermined condition holds among the first verification information, the second verification information, and the difference key; and
if the predetermined condition holds, authenticating the user to be authenticated identical to the user of the first biometric information used to generate the first sketch.
[Reference Literature 1] JP Patent Publication No. 721559
[Reference Literature 2] JP Patent Publication No. 2021-087167
[Reference Literature 3] Nicolosi, Antonio, et al. “Proactive Two-Party Signatures for User Authentication.” NDSS. 2003.
[Reference Literature 4] Lindell, Yehuda. “Fast secure two-party ECDSA signing.” Advances in Cryptology-CRYPTO 2017: 37th Annual International Cryptology Conference, Santa Barbara, CA, USA, Aug. 20-24, 2017, Proceedings, Part II 37. Springer International Publishing, 2017
[Reference Literature 5] JP Patent Publication No. 5707311
[Reference Literature 6] JP Unexamined Patent Publication No. 2022-172069
[Reference Literature 7] Derler, David/Slamanig, Daniel. “Key-homomorphic signatures: definitions and applications to multiparty signatures and non-interactive zero-knowledge.” Designs, Codes and Cryptography, Vol. 87.

The disclosures of the above-described non-patent literature and reference literatures are incorporated herein by reference. Within the scope of the present disclosure (including the claims), it is possible to modify, adjust, or combine the embodiments or examples based on the basic technical concept. Furthermore, within the scope of the claims, various combinations or selections of disclosure elements (including each element of each note, each element of each embodiment, each element of each figure, etc.) are possible. That is, the present disclosure naturally includes all disclosures, including the claims, as well as various modifications, combinations and revisions that would be obvious to those skilled in the art based on the technical concept.

What is claimed is:

1. A signature system comprising:
at least first to third apparatuses, each of which includes at least a processor, a memory storing a program executable by the processor and a communication interface, wherein
the processor included in the first apparatus is configured to:
generate a first sketch using first biometric information of a user and a first signing key;
generate first verification information based on the first signing key; and
transmit the first sketch and the first verification information to the third apparatus, wherein the processor included in the second apparatus is configured to:
generate a second sketch using second biometric information of a user and second signing key;
generate second verification information based on the second signing key; and
transmit the second sketch and the second verification information to the third apparatus,
wherein the third apparatus includes a storage part that stores N (where Nis an integer not less than 1) set(s) of the first sketch and the first verification information transmitted from one or more instances of the first apparatus, the processor included in the third apparatus configured to:
receive the second sketch and the second verification information transmitted from the second apparatus;
for the N set(s) of the first sketch and the first verification information stored in the storage part,
restore a difference key by using the first sketch of a kth set (where k is an integer not less than 1 and not more than N) and the second sketch; and
identify an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

2. The signature system according to claim 1, wherein the processor included in the first apparatus is configured to
generate the first verification information by applying homomorphic one-way function to the first signing key, and
wherein the processor included in the second apparatus is configured to
generate the second verification information by applying the homomorphic one-way function to the second signing key.

3. The signature system according to claim 2, wherein the processor included in the third apparatus is configured to
determine whether an additive homomorphic relation holds among
between an operation result of a value obtained by applying a homomorphic one-way function to the difference key restored by using the first sketch of the kth set and the second sketch and the second verification information obtained by applying the homomorphic one-way function to the second signing key; and
the first verification information of the set obtained by applying the homomorphic one-way function to the first signing key.

4. The signature system according to claim 1, wherein the processor included in the third apparatus is configured to
transmit the user ID identified to the second apparatus, and
wherein the processor included in the second apparatus is configured to
generate a signature for a message to be signed using the second biometric information.

5. The signature system according to claim 1, further including
a fourth apparatus including a processor, a memory storing a program executable by the processor, a communication interface and a storage,
wherein the processor included in the fourth apparatus is configured to
receive and store in a storage a verification key for each user to perform signature verification, and
wherein the processor included in the second apparatus is configured to
transmit the user ID, the signature, and the message to the fourth apparatus, the processor included in the fourth apparatus configured to verify the signature for the message using the verification key corresponding to the user ID.

6. The signature system according to claim 4, wherein the processor included in the second apparatus and the processor included in the third apparatus are configured to:
communicate with each other in accordance with a signature generation protocol; and
generate first and second distributed signature using the second signing key and the difference key, respectively, and
wherein the processor included in one of the second apparatus or the third apparatus is configured to
combine the first and second distributed signatures to generate a signature equivalent to a signature generated for the message using the first signing key.

7. The signature system according to claim 5, wherein the processor included in the second apparatus is configured to:
generate the second signing key and a second verification key;
generate a signature for the message using the second signing key; and
transmit the signature, the second verification key, and the second sketch to a fourth apparatus,
wherein the processor included in the first apparatus is configured to
transmit the verification key and the first sketch to the fourth apparatus, and
wherein the processor included in the fourth apparatus is configured to:
verify the signature with the second verification key; and
generate a difference key using the first sketch and the second sketch; and
verify whether the verification key corresponding to the user ID, the second verification key, and the difference key satisfy a predetermined relation.

8. The signature system according to claim 1, wherein the third apparatus is configured to
compute a distance between the first biometric information and the second biometric information using a difference between the first sketch and the second sketch, and the difference key to verify whether the distance is within a predetermined threshold.

9. The signature system according to claim 1, wherein the third apparatus includes the storage part that stores the set of the first sketch and the first verification information in a set of columns in a record,
a row number of the record including the kth set of the first sketch and the first verification information in the storage part that satisfies the predetermined condition being set as the user ID, or a value of the user ID field of the record being set as the user ID.

10. A signature method comprising:
by a first apparatus:
generating a first sketch using first biometric information of a user and a first signing key;
generating first verification information based on the first signing key; and
transmitting the first sketch and the first verification information to a third apparatus, the method comprising:
by the second apparatus:
generating a second sketch using second biometric information of the user and second signing key;
generating second verification information based on the second signing key; and
transmitting the second sketch and the second verification information to the third apparatus, the method comprising:
by the third apparatus including a storage part that stores N (where N is an integer not less than 1) set(s) of the first sketch and the first verification information received from one or more instances of the first apparatus:
on reception of the second sketch and the second verification information transmitted from the second apparatus,
for the N set(s) of the first sketch and the first verification information stored in the storage part,
restoring a difference key by using the first sketch of a kth set (where k is an integer not less than 1 and not more than N) and the second sketch; and
identifying an ID (identification information), as a user ID, the ID corresponding to the kth set of the first sketch and the first verification information, wherein the first verification information of the kth set, the second verification information and the difference key restored by using the first sketch of the kth set and the second sketch satisfy a predetermined condition.

11. The signature method according to claim 10, comprising:
generating, by the first apparatus, the first verification information by applying a homomorphic one-way function to the first signing key; and
generating, by the second apparatus, the second verification information by applying the homomorphic one-way function to the second signing key.

12. The signature method according to claim 11, comprising:
determining, by the third apparatus, whether an additive homomorphic relation holds between an operation result of a value obtained by applying a homomorphic one-way function to the difference key restored by using the first sketch of the kth set and the second sketch and the second verification information obtained by applying the homomorphic one-way function to the second signing key; and
the first verification information of the set obtained by applying the homomorphic one-way function to the first signing key.

13. The signature method according to claim 10, comprising:
transmitting, by the third apparatus, the identified user ID to the second apparatus; and
generating, by a second apparatus, a signature for the message to be signed using the second biometric information.

14. The signature method according to claim 10, comprising:
transmitting, by the second apparatus, the user ID, the signature, and the message to a fourth apparatus that stores and retains a verification key for each user and performs signature verification; and
on reception of the user ID, the signature, and the message,
verifying, by the fourth apparatus, the signature for the message using the verification key corresponding to the user ID.

15. The signature method of claim 13, comprising:
communicating, by the second apparatus and the third apparatus, with each other in accordance with a signature generation protocol,
generating, by the second apparatus and the third apparatus, first and second distributed signature using the second signing key and the difference key, respectively; and
combining, by one of the second apparatus or the third apparatus, the first and second distributed signatures to generate a signature equivalent to a signature generated for the message using the first signing key.

16. The signature method according to claim 14, comprising:
by the second apparatus:
generating the second signing key and the second verification key,
generating a signature for the message using the second signing key, and
transmitting the signature, the second verification key, and the second sketch to the fourth apparatus,
the method comprising
by the first apparatus,
transmitting the verification key and the first sketch to the fourth apparatus, the method comprising:
by the fourth apparatus:
verifying the signature using the second verification key;
restoring a difference key using the first sketch and the second sketch; and
verifying whether the verification key corresponding to the user ID, the second verification key, and the difference key satisfy a predetermined relation.

17. The signature method according to claim 10, comprising
computing, by the third apparatus, a distance between the first biometric information and the second biometric information using a difference between the first sketch and the second sketch and the difference key to verify whether the distance is within a predetermined threshold.

18. A user ID identification apparatus including at least a processor, a memory storing a program executable by the processor, and a communication interface, wherein the processor is configured to:
receive a first sketch generated using first biometric information and a first signing key, and first verification information generated based on the first signing key and store a set of the first sketch and the first verification information in a storage part;
receive a second sketch generated using second biometric information and second signing key, and second verification information generated based on the second signing key;
restore a difference key using the first sketch stored in the storage and the second sketch, for one or more sets of the first sketch and the first verification information; and
identify, an ID (identification information) corresponding to a set of the first sketch and the first verification information with a predetermined condition regarding the first verification information of the set, the second verification information, and the difference key being met, as a user ID.
